(19) United States
(12) Patent Application Publication
(10) Pub. No.: US 2025/0063457 A1
(43) Pub. Date: Feb. 20, 2025

(54) MANAGING CANDIDATE CELL CONFIGURATIONS FOR CONDITIONAL PREPARATION PROCEDURES

(71) Applicant: GOOGLE LLC, Mountain View, CA (US)

(72) Inventors: Ching- Jung Hsieh, Taipei City (TW); Chih-Hsiang Wu, Taoyuan City (TW)

(21) Appl. No.: 18/726,042

(22) PCT Filed: Jan. 6, 2023
(86) PCT No.: PCT/US23/10271

§ 371 Date: Jul. 1, 2024

Related U.S. Application Data
(60) Provisional application No. 63/297,076, filed on Jan. 6, 2022.

(51) Int. Cl. H04W 36/36; H04W 36/00

(52) U.S. Cl. CPC H04W 36/362; H04W 36/0058

(57) ABSTRACT

A method and system for managing candidate cell configuration for a user equipment (UE) initially in communication with at least a first node is disclosed herein. The method is implemented in a second node and comprises receiving, by the second node and from the first node, a request for connectivity with the second node, the request including at least a procedure indicator; and transmitting, by the second node to the first node and depending on the procedure indicator, one of a list of two or more conditional configurations or a single conditional configuration, the list of two or more conditional configurations or the single conditional configuration to be used by the UE.

### FIELD OF THE DISCLOSURE

This disclosure relates generally to wireless communications and, more particularly, to managing conditional configurations for multi-connectivity such as conditional handover and conditional secondary node addition or change procedures.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, a user equipment (UE) can concurrently utilize resources from multiple radio access network (RAN) nodes, such as base stations or components of a distributed base station, interconnected by a backhaul. When the network nodes support different radio access technologies (RATs), the connectivity type is referred to as Multi-Radio Dual Connectivity (MR-DC). When a UE operates in MR-DC, one base station operates as a master node (MN) that covers a primary cell (PCell), and the other base station operates as a secondary node (SN) that covers a primary secondary cell (PSCell). The UE communicates with the MN via the PCell and the SN via the PSCell. In other scenarios, the UE transfers a wireless connection from one base station to another base station. For example, a serving base station can determine to hand the UE over to a target base station and initiate a handover procedure.

3GPP specification TS 37.340 v16.6.0 describes procedures for a UE to add or change an SN in dual connectivity (DC) scenarios. These procedures involve messaging (e.g., RRC signaling and preparation) between RAN nodes. This messaging generally causes latency, which in turn increases the probability that the SN addition or SN change procedure will fail. These legacy procedures, which do not involve conditions that are checked at the UE, can be referred to as “immediate” SN addition and SN change procedures.

More recently, for both SN and PSCell addition/change, conditional procedures have been considered (i.e., conditional SN or PSCell addition/change). Unlike the immediate procedures discussed above, conditional procedures do not add or change the SN or PSCell, or perform the handover, until the UE determines that a condition is satisfied.

To configure a conditional procedure, the RAN provides the condition to the UE, along with a configuration that will enable the UE to communicate with the appropriate base station, or via the appropriate cell, when the condition is satisfied. For a conditional addition of a base station as an SN or a candidate cell as a PSCell, for example, the RAN provides the UE with a condition to be satisfied before the UE can add that base station as the SN or that candidate cell as the PSCell, and a configuration that enables the UE to communicate with that base station or PSCell after the condition has been satisfied.

In the immediate PSCell addition or change procedure, the RAN (i.e., MN or SN) transmits an RRC reconfiguration message including multiple configuration parameters to the UE, and the UE attempts to connect to a (target) PSCell configured by the RRC reconfiguration message. After the UE successfully connects to the SN via the PSCell, the UE communicates with the SN on the PSCell by using the multiple configuration parameters and security key(s) associated with the PSCell and derived from one or more security configuration parameters in the RRC reconfiguration message. The SN also derives security key(s) which match the security key(s) derived from the UE. After the UE successfully connects to the PSCell, the RAN (e.g., the SN) communicates data with the UE by using the matching security key(s) and the multiple configuration parameters.

Using present techniques, when the MN completes the configuration for conditional SN procedure (e.g., conditional SN addition or conditional SN cell change), the MN cannot determine which candidate secondary cell the UE will connect to in the future. Moreover, because the UE connects to the secondary cell only subject to the fulfillment of one or more conditions, the MN cannot determine whether the UE will connect to any of the candidate cells.

Conditional procedures present certain challenges for managing candidate configurations such as CHO configuration(s) and/or C-SN configuration(s) in a correct and timely manner. The management can involve preparing and proceeding with the candidate configuration(s). For example, during a CHO preparation for a UE, a candidate MN may configure dual connectivity with an SN for the UE. It is not clear how the candidate MN and the SN prepare dual connectivity for the UE. In another example, while a MN initiates a CHO procedure, the MN may receive from an SN a request for a conditional PSCell change. In this case, it is not clear how the MN handles the request.

### SUMMARY

One example embodiment of these techniques is a method for managing candidate cell configuration for a user equipment (UE) initially in communication with at least a first node, the method implemented in a second node and comprising: receiving, by the second node and from the first node, a request for connectivity with the second node, the request including at least a procedure indicator; and transmitting, by the second node to the first node and depending on the procedure indicator, one of a list of two or more conditional configurations or a single conditional configuration, the list of two or more conditional configurations or the single conditional configuration to be used by the UE.

Another example embodiment of these techniques is a method for managing candidate cell configuration for a user equipment (UE) initially in communication with at least a first node, the method implemented in the first node and comprising: transmitting, by the first node and to a second node, a request for connectivity with the second node including an indication of at least one of (i) a conditional handover (CHO) or (ii) an addition or change for a conditional primary secondary cell (C-PSCell); in response to transmitting the request for connectivity, receiving, by the first node and from the second node, a response with an information element configured to include a list of two or more conditional configurations or a single conditional configuration based at least on the indication; and transmitting, by the first node, a radio resource message based at least on the list of two or more conditional configurations or the single conditional configuration.

### BRIEF DESCRIPTION OF THE DRAWINGS

FIG. 1A is a block diagram of an example system in which a base station and/or a user equipment (UE) can implement the techniques of this disclosure for managing conditional procedures related to a master node (MN) or a secondary node (SN);

FIG. 1B is another block diagram of an example system in which a radio access network (RAN) and a user device can implement the techniques of this disclosure for managing conditional procedures related to an MN or an SN;

FIG. 1C is a block diagram of an example base station including a central unit (CU) and a distributed unit (DU) that can operate in the system of FIG. 1A or FIG. 1B;

FIG. 2 is a block diagram of an example protocol stack according to which the UE of FIGS. 1A-1B can communicate with base stations;

FIG. 3A illustrates an example scenario in which an MN receives and processes one or more SN configurations from a conditional SN (C-SN) during a C-SN addition procedure;

FIG. 3B illustrates a scenario similar to that of FIG. 3A, but in which the C-SN addition procedure is explicitly MN-initiated;

FIG. 3C illustrates a scenario similar to that of FIG. 3A, but in which the C-SN addition procedure is explicitly SN-initiated;

FIG. 4A illustrates an example scenario in which an MN initiates a conditional handover (CHO) with a conditional MN (C-MN) and the C-MN further performs a C-SN addition procedure for a secondary cell group (SCG) configuration;

FIG. 4B illustrates a scenario similar to that of FIG. 4A, but in which the C-SN addition procedure is for a conditional primary-secondary cell (PSCell) addition or change (CPAC) configuration;

FIG. 4C illustrates a scenario similar to that of FIG. 4B, but in which the handover is an immediate handover (IHO) with a target MN (T-MN) rather than a conditional handover with a C-MN;

FIG. 4D illustrates a scenario similar to that of FIG. 4B, but in which the MN initiates a handover cancel procedure after beginning the CHO;

FIG. 4E illustrates a scenario similar to that of FIG. 4D, but in which a C-MN initiates the handover cancel procedure;

FIG. 4F illustrates a scenario similar to that of FIG. 4D, but in which the MN initiates the handover cancel procedure due to a determination to perform an IHO;

FIG. 5A illustrates an example scenario in which an MN initiates a CHO procedure between two distributed units in the MN with a C-SN addition procedure for an SCG configuration;

FIG. 5B illustrates a scenario similar to that of FIG. 5A, but in which the C-SN addition procedure is for a CPAC configuration;

FIG. 5C illustrates a scenario similar to that of FIG. 5A, but in which the MN cancels the handover and/or conditional configuration(s);

FIG. 5D illustrates a scenario similar to that of FIG. 5C, but in which the MN initiates the handover cancel procedure due to a determination to perform an IHO between two distributed units in the MN;

FIG. 6 is a flow diagram of an example method for performing a conditional SN procedure with a C-SN and determining whether the SN is allowed to generate a single conditional configuration or a list of configurations, implemented in an MN;

FIG. 7A is a flow diagram of an example method for performing a conditional SN procedure with an MN and determining whether to generate a single conditional configuration or a list of configurations based on whether an SN request message includes a conditional indicator, implemented in an SN;

FIG. 7B is a flow diagram of an example method similar to that of FIG. 7A, but in which the SN makes the determination based on whether the SN request message includes a CHO indicator or a CPAC indicator, implemented in an SN;

FIG. 8 is a flow diagram of an example method for performing a conditional SN procedure with a C-SN and indicating to the C-SN to generate at most one conditional configuration, implemented in an MN;

FIG. 9 is a flow diagram of an example method for performing a conditional SN procedure with a C-SN and generating an RRC message including a conditional configuration, implemented in an MN;

FIG. 10 is a flow diagram of an example method similar to that of FIG. 7A, but in which the SN makes generates the conditional configuration or list of configurations based on cells with measurement results above a predetermined threshold, implemented in an SN;

FIG. 11A is a flow diagram of an example method for performing a conditional SN procedure with an SN and determining how to retrieve RRC messages and/or the conditional configuration or list of configurations from an SN response, implemented in an MN;

FIG. 11B is a flow diagram of an example method similar to that of FIG. 11A, but in which the MN makes the determination based on whether the SN request message included a CPAC indicator, implemented in an MN;

FIG. 12A is a flow diagram of an example method for indicating to the SN and preventing the SN from performing a conditional SN procedure, implemented in an MN; and

FIG. 12B is a flow diagram of an example method similar to that of FIG. 12A, but in which the MN prevents the SN from performing the conditional SN procedure in response to receiving a message from the SN, implemented in an MN.

### DETAILED DESCRIPTION OF THE DRAWINGS

As discussed in detail below, a UE and/or one or more base stations manage conditional procedures, such as conditional PSCell addition or change (CPAC). This disclosure may also refer to a conditional PSCell addition procedure and a conditional PSCell change procedure separately using the acronyms CPA and CPC, respectively.

According to an implementation, a network node manages candidate cell configuration for a UE by transmitting a request for connectivity with a conditional secondary node to the conditional secondary node in question. The conditional secondary node responds with an information element (IE) configured to include either a list of configurations or a single conditional configuration, depending on the contents of the request for connectivity. The request for connectivity can include, for example, a conditional indicator, a conditional handover (CHO) request, a conditional primary-secondary cell (PSCell) addition or change (CPAC) indicator, etc.

After the network node receives the response from the conditional secondary node and the condition is fulfilled, the network node facilitates communications with the UE. As used herein, the term “condition” may refer to a single, detectable state or event (e.g., a particular signal quality metric exceeding a threshold), or to a logical combination of such states or events (e.g., “Condition A and Condition B,” or “(Condition A or Condition B) and Condition C”, etc.). Alternatively, after receiving the response from the conditional secondary node but before the condition is fulfilled, the process may be interrupted by a CHO or immediate handover (IHO) event. The network node then decides whether to delay or cancel the candidate cell configuration or the handover event.

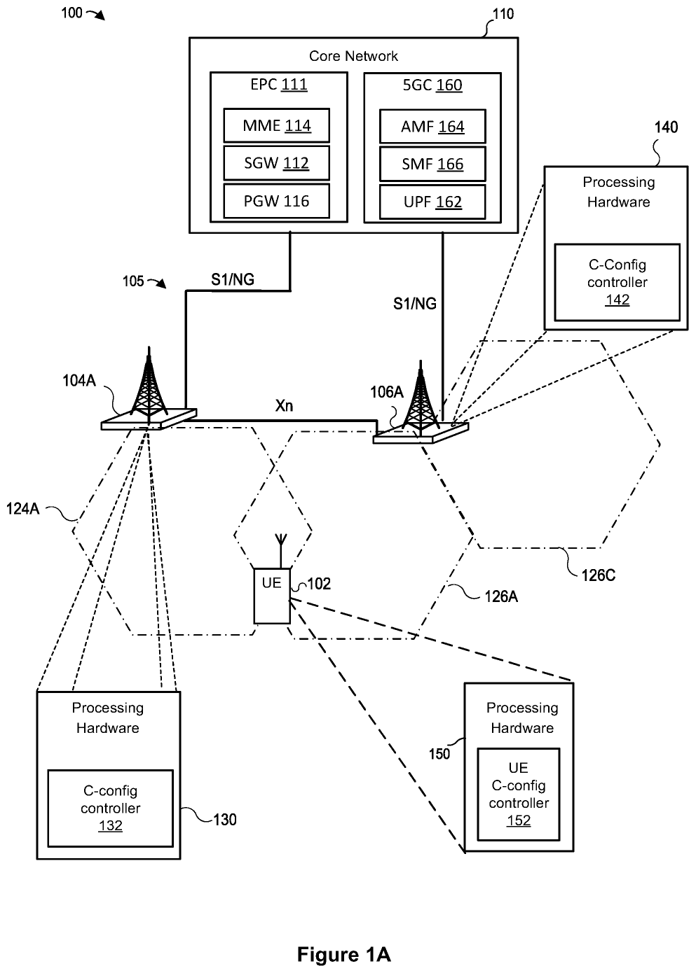

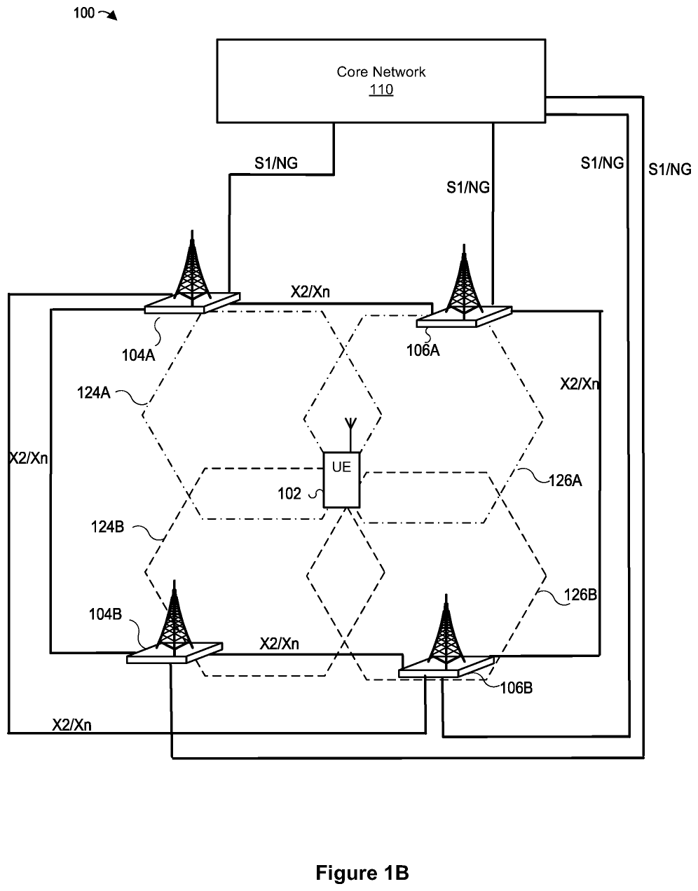

Referring first to FIG. 1A, an example wireless communication system 100 includes a UE 102, a base station (BS) 104A, a base station 106A, and a core network (CN) 110. The base stations 104A and 106A can operate in a RAN 105 connected to the same core network (CN) 110. The CN 110 can be implemented as an evolved packet core (EPC) 111 or a fifth generation (5G) core (5GC) 160, for example.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc.; the AMF 164 is configured to manage authentication, registration, paging, and other related functions; and the SMF 166 is configured to manage PDU sessions.

As illustrated in FIG. 1A, the base station 104A supports a cell 124A, and the base station 106A supports a cell 126A. Further, each of the base stations 104A, 106A may support more than one cell. The base station 106A, for example, may also support a cell 126C. The cells 124A and 126A can partially overlap, so that the UE 102 can communicate in DC with the base station 104A and the base station 106A operating as a master node (MN) and a secondary node (SN), respectively. To directly exchange messages during DC scenarios and other scenarios discussed below, the MN 104A and the SN 106A can support an X2 or Xn interface. In general, the CN 110 can connect to any suitable number of base stations supporting NR cells and/or EUTRA cells. An example configuration in which the EPC 110 is connected to additional base stations is discussed below with reference to FIG. 1B.

The base station 104A is equipped with processing hardware 130 that can include one or more general-purpose processors such as CPUs and non-transitory computer-readable memory storing machine-readable instructions executable on the one or more general-purpose processors, and/or special-purpose processing units. The processing hardware 130 in an example implementation includes a conditional configuration controller 132 configured to manage conditional configuration for one or more conditional procedures such as Conditional Handover (CHO), Conditional PSCell Addition or Change (CPAC), or Conditional SN Additional or Change (CSAC), when the base station 104A operates as an MN.

The base station 106A is equipped with processing hardware 140 that can also include one or more general-purpose processors such as CPUs and non-transitory computer-readable memory storing machine-readable instructions executable on the one or more general-purpose processors, and/or special-purpose processing units. The processing hardware 140 in an example implementation includes a conditional configuration controller 142 configured to manage conditional configurations for one or more conditional procedures such as CHO, CPAC, or CSAC, when the base station 106A operates as an SN.

Still referring to FIG. 1A, the UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes a UE conditional configuration controller 152 configured to manage conditional configuration for one or conditional procedures.

More particularly, the conditional configuration controllers 132, 142, and 152 can implement at least some of the techniques discussed with reference to the messaging and flow diagrams below. Although FIG. 1A illustrates the conditional configuration controllers 132 and 142 as separate components, in at least some of the scenarios the base stations 104A and 106A can have similar implementations and in different scenarios operate as MN or SN nodes. In these implementations, each of the base stations 104A and 106A can implement both the conditional configuration controller 132 and the conditional configuration controller 142 to support MN and SN functionality, respectively.

In operation, the UE 102 can use a radio bearer (e.g., a DRB or an SRB) that at different times terminates at the MN 104A or the SN 106A. The UE 102 can apply one or more security keys when communicating on the radio bearer, in the uplink (from the UE 102 to a BS) and/or downlink (from a base station to the UE 102) direction. The UE in some cases can use different RATs to communicate with the base stations 104A and 106A. Although the examples below may refer specifically to specific RAT types, 5G NR or EUTRA, in general the techniques of this disclosure also can apply to other suitable radio access and/or core network technologies.

FIG. 1B depicts additional base stations 104B and 106B, which may be included in the wireless communication system 100. The UE 102 initially connects to the base station 104A. The BSs 104B and 106B may have similar processing hardware as the base station 106A. The UE 102 initially connects to the base station 104A.

In some scenarios, the base station 104A can perform immediate SN addition to configure the UE 102 to operate in dual connectivity (DC) with the base station 104A (via a PCell) and the base station 106A (via a PSCell other than cell 126A). The base stations 104A and 106A operate as an MN and an SN for the UE 102, respectively. The UE 102 in some cases can operate using the MR-DC connectivity mode, e.g., communicate with the base station 104A using 5G NR and communicate with the base station 106A using EUTRA, or communicate with the base station 104A using EUTRA and communicate with the base station 106A using 5G NR. Multi-connectivity coordination can help the two base stations coordinate shared UE capabilities including operational frequencies (e.g., band combinations, frequency ranges), UE measurements and reporting (e.g., intra-frequency measurements, inter-frequency measurements, inter-RAT measurements, measurement gaps), reception timing (e.g., DRX configurations, offset timing), and uplink power control (e.g., power headroom, maximum transmit power).

At some point, the MN 104A can perform an immediate SN change to change the SN of the UE 102 from the base station 106A (source SN, or “S-SN”) to the base station 104B (target SN, or “T-SN”) while the UE 102 is communicating in DC with the MN 104A and the S-SN 106A. In another scenario, the SN 106A can perform an immediate PSCell change to change the PSCell of the UE 102 to the cell 126A. In one implementation, the SN 106A can transmit a configuration changing the PSCell to cell 126A to the UE 102 via a signaling radio bearer (SRB) (e.g., SRB3) for the immediate PSCell change. In another implementation, the SN 106A can transmit a configuration changing the PSCell to the cell 126A to the UE 102 via the MN 104A for the immediate PSCell change. The MN 104A may transmit the configuration immediately changing the PSCell to the cell 126A to the UE 102 via SRB1. Extending multi-connectivity coordination can help the newly-added base station coordinate shared UE capabilities.

In other scenarios, the base station 104A can perform a conditional SN Addition procedure to first configure the base station 106B as a C-SN for the UE 102, i.e., conditional SN addition or change (CSAC). At this time, the UE 102 can be in single connectivity (SC) with the base station 104A or in DC with the base station 104A and the base station 106A. If the UE 102 is in DC with the base station 104A and the base station 106A, the MN 104A may determine to perform the conditional SN Addition procedure in response to a request received from the base station 106A or in response to one or more measurement results received from the UE 102 or obtained by the MN 104A from measurements on signals received from the UE 102. In contrast to the immediate SN Addition case discussed above, the UE 102 does not immediately attempt to connect to the C-SN 106B. In this scenario, the base station 104A again operates as an MN, but the base station 106B initially operates as a C-SN rather than an SN.

More particularly, when the UE 102 receives a configuration for the C-SN 106B, the UE 102 does not connect to the C-SN 106B until the UE 102 has determined that a certain condition is satisfied (the UE 102 in some cases can consider multiple conditions, but for convenience only the discussion below refers to a single condition). Before the condition is satisfied, multi-connectivity coordination is not necessary; however, it will be helpful as soon as a C-SN becomes connected. When the UE 102 determines that the condition has been satisfied, the UE 102 connects to the C-SN 106B, so that the C-SN 106B begins to operate as the SN 106B for the UE 102. Thus, while the base station 106B operates as a C-SN rather than an SN, the base station 106B is not yet connected to the UE 102, and accordingly is not yet servicing the UE 102. In some implementations, the UE 102 may disconnect from the SN 106A to connect to the C-SN 106B.

In yet other scenarios, the UE 102 is in DC with the MN 104A (via a PCell) and SN 106A (via a PSCell other than cell 126A and not shown in FIG. 1A). The SN 106A can perform conditional PSCell addition or change (CPAC) to configure a candidate PSCell (C-PSCell) 126A for the UE 102. If the UE 102 is configured a signaling radio bearer (SRB) (e.g., SRB3) to exchange RRC messages with the SN 106A, the SN 106A may transmit a configuration for the C-PSCell 126A to the UE 102 via the SRB, e.g., in response to one or more measurement results which may be received from the UE 102 via the SRB or via the MN 104A or may be obtained by the SN 106A from measurements on signals received from the UE 102. In case of via the MN 104A, the MN 104A receives the configuration for the C-PSCell 126A. In contrast to the immediate PSCell change case discussed above, the UE 102 does not immediately disconnect from the PSCell and attempt to connect to the C-PSCell 126A.

More particularly, when the UE 102 receives a configuration for the C-PSCell 126A, the UE 102 does not connect to the C-PSCell 126A until the UE 102 has determined that a certain condition is satisfied (the UE 102 in some cases can consider multiple conditions, but for convenience only the discussion below refers to a single condition). When the UE 102 determines that the condition has been satisfied, the UE 102 connects to the C-PSCell 126A, so that the C-PSCell 126A begins to operate as the PSCell 126A for the UE 102. Thus, while the cell 126A operates as a C-PSCell rather than a PSCell, the SN 106A might not yet connect to the UE 102 via the cell 126A. In some implementations, the UE 102 may disconnect from the PSCell to connect to the C-PSCell 126A.

In some scenarios, the condition associated with CSAC or CPAC can be signal strength/quality, which the UE 102 detects on the C-PSCell 126A of the SN 106A or on a C-PSCell 126B of C-SN 106B, exceeding a certain threshold or otherwise corresponding to an acceptable measurement. For example, when the one or more measurement results the UE 102 obtains on the C-PSCell 126A are above a threshold configured by the MN 104A or the SN 106A or above a pre-determined or pre-configured threshold, the UE 102 determines that the condition is satisfied. When the UE 102 determines that the signal strength/quality on the C-PSCell 126A of the SN 106A is sufficiently good (again, measured relative to one or more quantitative thresholds or other quantitative metrics), the UE 102 can perform a random access procedure on the C-PSCell 126A with the SN 106A to connect to the SN 106A. After the UE 102 successfully completes the random access procedure on the C-PSCell 126A, the C-PSCell 126A becomes a PSCell 126A for the UE 102. The SN 106A then can start communicating data (user-plane data or control-plane data) with the UE 102 through the PSCell 126A. In another example, when the one or more measurement results the UE 102 obtains on the C-PSCell 126B are above a threshold configured by the MN 104A or the C-SN 106B or above a pre-determined or pre-configured threshold, the UE 102 determines that the condition is satisfied. When the UE 102 determines that the signal strength/quality on the C-PSCell 126B of the C-SN 106B is sufficiently good (again, measured relative to one or more quantitative thresholds or other quantitative metrics), the UE 102 can perform a random access procedure on the C-PSCell 126B with the C-SN 106B to connect to the C-SN 106B. After the UE 102 successfully completes the random access procedure on the C-PSCell 126B, the C-PSCell 126B becomes a PSCell 126B for the UE 102 and the C-SN 106B becomes an SN 106B. The SN 106B then can start communicating data (user-plane data or control-plane data) with the UE 102 through the PSCell 126B.

In various configurations of the wireless communication system 100, the base station 104A can be implemented as a master eNB (MeNB) or a master gNB (MgNB), and the base station 106A or 106B can be implemented as a secondary gNB (SgNB) or a candidate SgNB (C-SgNB). The UE 102 can communicate with the base station 104A and the base station 106A or 106B (106A/B) via the same RAT such as EUTRA or NR, or different RATs. When the base station 104A is an MeNB and the base station 106A is an SgNB, the UE 102 can be in EUTRA-NR DC (EN-DC) with the MeNB and the SgNB. In this scenario, depending on the implementation, the MeNB 104A might or might not configure the base station 106B as a C-SgNB to the UE 102. In this scenario, the SgNB 106A may configure cell 126A as a C-PSCell to the UE 102. When the base station 104A is an MeNB and the base station 106A is a C-SgNB for the UE 102, the UE 102 can be in SC with the MeNB. In this scenario, the MeNB 104A might or might not configure the base station 106B as another C-SgNB to the UE 102.

In some cases, an MeNB, an SeNB or a C-SgNB is implemented as an ng-cNB rather than an eNB. When the base station 104A is a Master ng-cNB (Mng-eNB) and the base station 106A is a SgNB, the UE 102 can be in next generation (NG) EUTRA-NR DC (NGEN-DC) with the Mng-eNB and the SgNB. In this scenario, the MeNB 104A might or might not configure the base station 106B as a C-SgNB to the UE 102. In this scenario, the SgNB 106A may configure cell 126A as a C-PSCell to the UE 102. When the base station 104A is an Mng-NB and the base station 106A is a C-SgNB for the UE 102, the UE 102 can be in SC with the Mng-NB. In this scenario, the Mng-eNB 104A might or might not configure the base station 106B as another C-SgNB to the UE 102.

When the base station 104A is an MgNB and the base station 106A/B is an SgNB, the UE 102 may be in NR-NR DC (NR-DC) with the MgNB and the SgNB. In this scenario, the MeNB 104A might or might not configure the base station 106B as a C-SgNB to the UE 102. In this scenario, the SgNB 106A may configure cell 126A as a C-PSCell to the UE 102. When the base station 104A is an MgNB and the base station 106A is a C-SgNB for the UE 102, the UE 102 may be in SC with the MgNB. In this scenario, the MgNB 104A might or might not configure the base station 106B as another C-SgNB to the UE 102.

When the base station 104A is an MgNB and the base station 106A/B is a Secondary ng-eNB (Sng-eNB), the UE 102 may be in NR-EUTRA DC (NE-DC) with the MgNB and the Sng-eNB. In this scenario, the MgNB 104A might or might not configure the base station 106B as a C-Sng-eNB to the UE 102. In this scenario, the Sng-eNB 106A may configure cell 126A as a C-PSCell to the UE 102. When the base station 104A is an MgNB and the base station 106A is a candidate Sng-eNB (C-Sng-eNB) for the UE 102, the UE 102 may be in SC with the MgNB. In this scenario, the MgNB 104A might or might not configure the base station 106B as another C-Sng-eNB to the UE 102.

The base stations 104A, 106A, and 106B can connect to the same core network (CN) 110 which can be an evolved packet core (EPC) 111 or a fifth-generation core (5GC) 160. The base station 104A can be implemented as an eNB supporting an SI interface for communicating with the EPC 111, an ng-eNB supporting an NG interface for communicating with the 5GC 160, or as a base station that supports the NR radio interface as well as an NG interface for communicating with the 5GC 160. The base station 106A can be implemented as an EN-DC gNB (en-gNB) with an SI interface to the EPC 111, an en-gNB that does not connect to the EPC 111, a gNB that supports the NR radio interface as well as an NG interface to the 5GC 160, or a ng-eNB that supports an EUTRA radio interface as well as an NG interface to the 5GC 160. To directly exchange messages during the scenarios discussed below, the base stations 104A, 106A, and 106B can support an X2 or Xn interface.

As illustrated in FIG. 1B, the base station 104A supports a cell 124A, the base station 104B supports a cell 124B, the base station 106A supports a cell 126A, and the base station 106B supports a cell 126B. The cells 124A and 126A can partially overlap, as can the cells 124A and 124B, so that the UE 102 can communicate in DC with the base station 104A (operating as an MN) and the base station 106A (operating as an SN) and, upon completing an SN change, with the base station 104A (operating as MN) and the SN 104B. More particularly, when the UE 102 operates in DC with the base station 104A and the base station 106A, the base station 104A operates as an MeNB, an Mng-cNB, or an MgNB, and the base station 106A operates as an SgNB or an Sng-eNB. The cells 124A and 126B can partially overlap. When the UE 102 is in SC with the base station 104A, the base station 104A operates as an MeNB, an Mng-eNB or an MgNB, and the base station 106B operates as a C-SgNB or a C-Sng-eNB. When the UE 102 operates in DC with the base station 104A and the base station 106A, the base station 104A operates as an MeNB, an Mng-cNB or an MgNB, the base station 106A operates as an SgNB or an Sng-eNB, and the base station 106B operates as a C-SgNB or a C-Sng-cNB.

In general, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure also can apply to other suitable radio access and/or core network technologies such as sixth generation (6G) radio access and/or 6G core network or 5G NR-6G DC.

FIG. 1C depicts an example distributed implementation of a base station 194 (e.g., any of the base station 104A, 104B, 106A, 106B or a similar base station). The base station in this implementation can include a central unit (CU) 172 and one or more distributed units (DUs) 174. The CU 172 is equipped with processing hardware that can include one or more general-purpose processors such as CPUs and non-transitory computer-readable memory storing machine-readable instructions executable on the one or more general-purpose processors, and/or special-purpose processing units. In one example, the CU 172 is equipped with the processing hardware 130. In another example, the CU 172 is equipped with the processing hardware 140. The processing hardware 140 in an example implementation includes an (C-)SN RRC controller configured to manage or control one or more RRC configurations and/or RRC procedures when the base station 194 operates as an SN or a candidate SN (C-SN). Depending on the implementation, the base station(s) 104A, 104B, 106A, and/or 106B can have hardware or functionality identical or similar to the base station 194. The DU 174 is also equipped with processing hardware that can include one or more general-purpose processors such as CPUs and non-transitory computer-readable memory storing machine-readable instructions executable on the one or more general-purpose processors, and/or special-purpose processing units. In some examples, the processing hardware in an example implementation includes a medium access control (MAC) controller configured to manage or control one or more MAC operations or procedures (e.g., a random access procedure) and a radio link control (RLC) controller configured to manage or control one or more RLC operations or procedures when the base station 194 operates as an MN, an SN or a candidate SN (C-SN). The processing hardware may include further a physical layer controller configured to manage or control one or more physical layer operations or procedures.

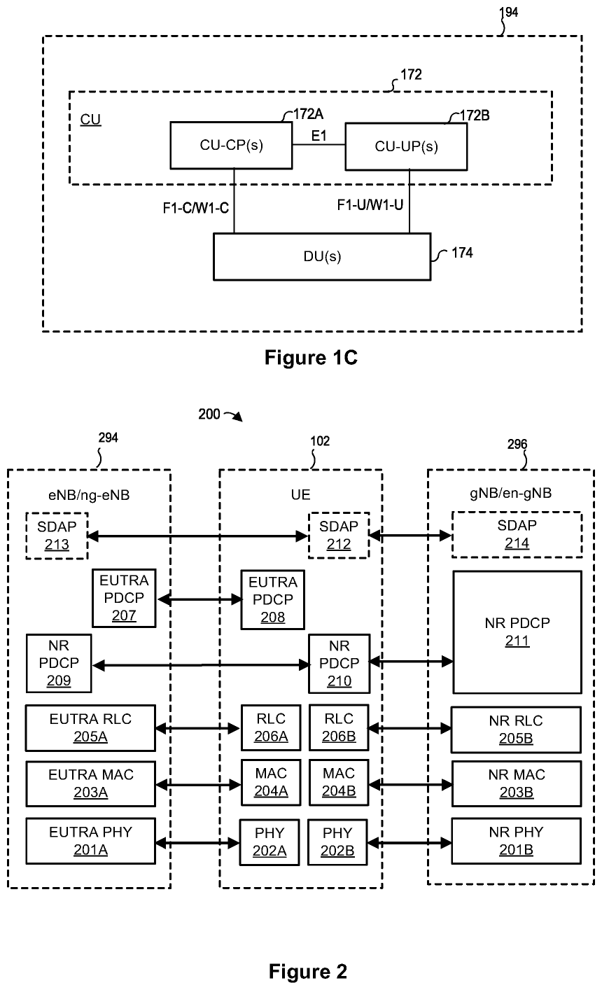

FIG. 2 illustrates, in a simplified manner, an example protocol stack 200 according to which the UE 102 can communicate with an eNB/ng-eNB or a gNB (e.g., one or more of the base stations 294, 296 similar to base stations 104A, 104B, 106A, 106B as described above with regard to FIGS. 1A-1C).

In the example stack 200, a physical layer (PHY) 202A (for UE 102) or 201A (for base station 294) of EUTRA provides transport channels to the EUTRA MAC sublayer 204A (for UE 102) or 203A (for base station 294), which in turn provides logical channels to the EUTRA RLC sublayer 206A (for UE 102) or 205A (for base station 294). The EUTRA RLC sublayer 205A/206A in turn provides RLC channels to a EUTRA PDCP sublayer 208 (for UE 102) or 207 (for base station 294) and, in some cases, to an NR PDCP sublayer 210 (for UE 102) or 209 (for base station 294). Similarly, the NR PHY 202B (for UE 102) or 201B (for base station 296) provides transport channels to the NR MAC sublayer 204B (for UE 102) or 203B (for base station 296), which in turn provides logical channels to the NR RLC sublayer 206B (for UE 102) or 205B (for base station 296). The NR RLC sublayer 205B/206B in turn provides data transfer services to the NR PDCP sublayer 210 (for UE 102) or 211 (for base station 296). The NR PDCP sublayer 210 in turn can provide data transfer services to Service Data Adaptation Protocol (SDAP) 212 (for UE 102), 213 (for base station 294), or 214 (for base station 296) or a radio resource control (RRC) sublayer (not shown in FIG. 2). The UE 102, in some implementations, supports both the EUTRA and the NR stack, as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and SDAP sublayer 212 over the NR PDCP sublayer 210.

The EUTRA PDCP sublayer 207/208 and the NR PDCP sublayer 209/210/211 receive packets (e.g., from an Internet Protocol (IP) layer, layered directly or indirectly over the PDCP layer 207/208 or 209/210/211) that can be referred to as service data units (SDUs), and output packets (e.g., to the RLC layer 205A/206A or 205B/206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 207/208 and the NR PDCP sublayer 209/210/211 can provide signaling radio bearers (SRBs) or an RRC sublayer (not shown in FIG. 2) to exchange RRC messages or non-access-stratum (NAS) messages, for example. On a user plane, the EUTRA PDCP sublayer 207/208 and the NR PDCP sublayer 209/210/211 can provide data radio bearers (DRBs) to support data exchange. Data exchanged on the NR PDCP sublayer 209/210/211 can be SDAP PDUs, Internet Protocol (IP) packets, or Ethernet packets.

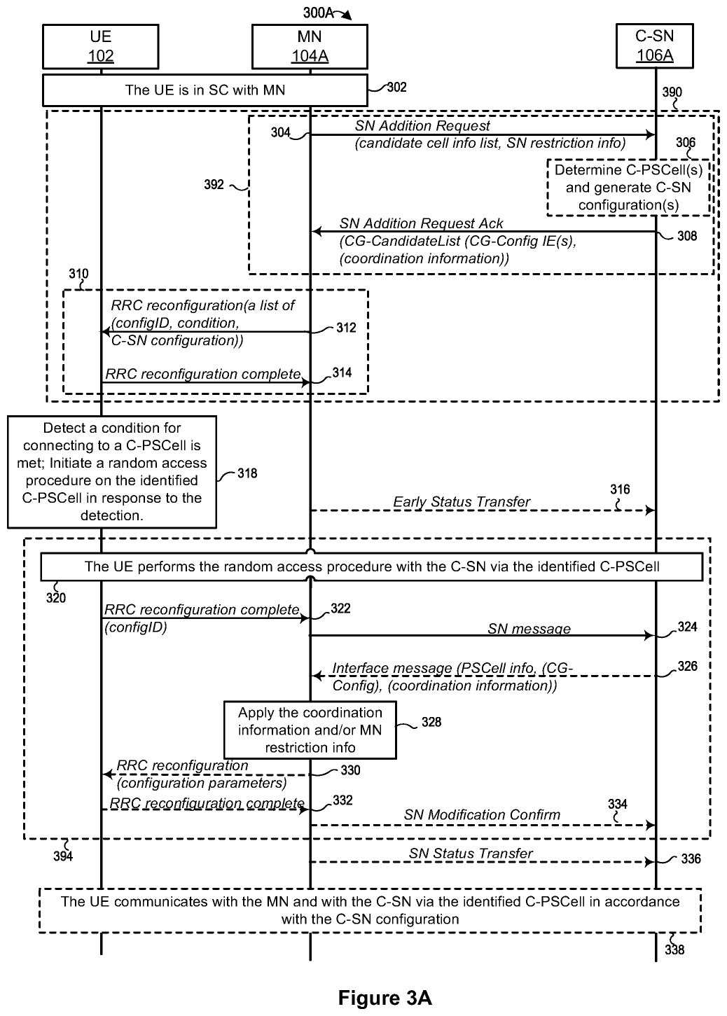

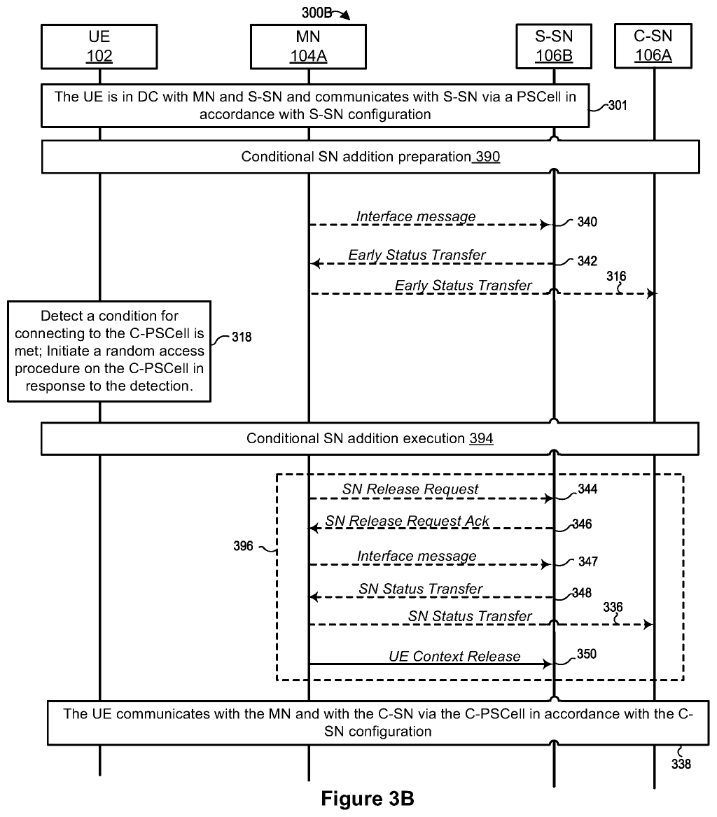

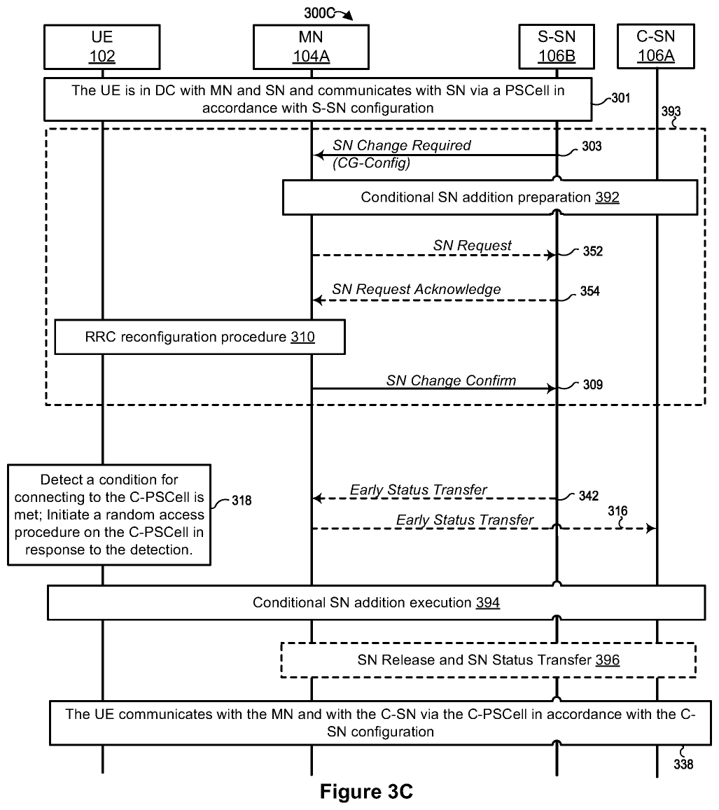

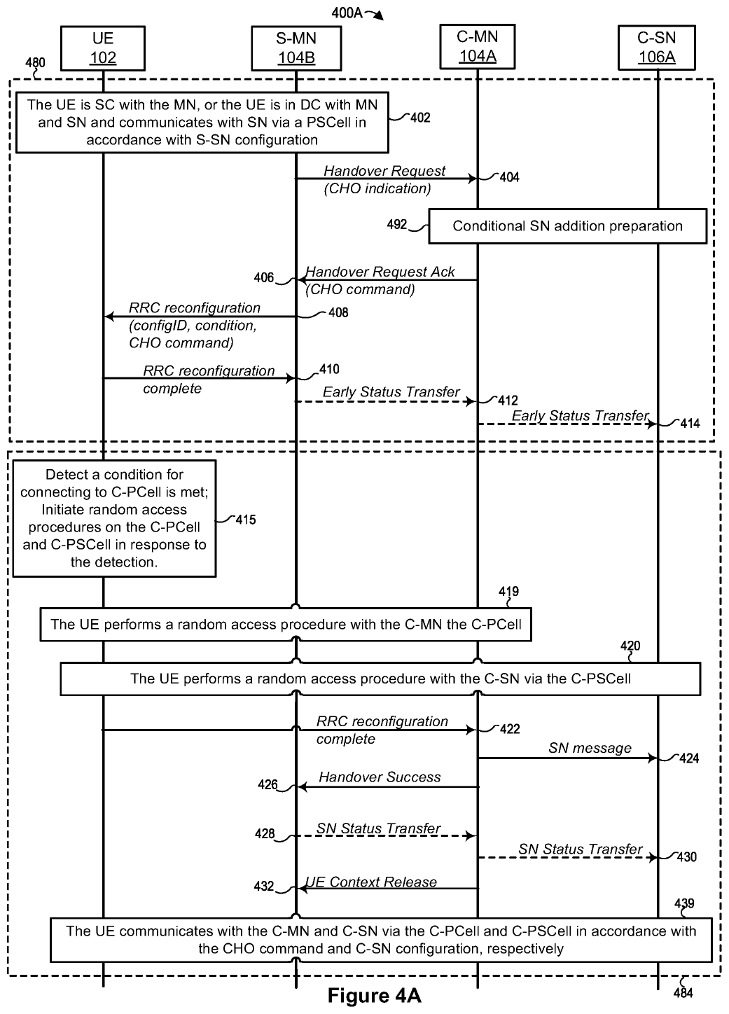

Next, several example scenarios in which a UE and/or a RAN perform the techniques of this disclosure for supporting conditional procedures are discussed with reference to FIGS. 3A-3F, 4A-4F, and 5A-5D. FIGS. 3A-3F, 4A-4F, and 5A-5D illustrate several example scenarios in which a UE and RAN nodes perform methods for supporting conditional procedures. Generally speaking, similar events in FIGS. 3A-3F, 4A-4F, and 5A-5D are labeled with the same reference numbers, with differences discussed below where appropriate. Time flows from top to bottom of these scenario illustrations, that is, earlier events or actions are represented above the later ones.

Referring first to FIG. 3A, in a scenario 300A, an MN receives and processes one or more SN configurations from the SN during a conditional SN addition procedure. In the scenario 300A, the base station 104A in a scenario 300A operates as an MN, and the base station 106A operates as a C-SN. Initially, the UE 102 operates 302 in single connectivity (SC) with the MN 104A. While in SC, the UE 102 transmits UL PDUs and/or DL PDUs with the MN 104A (e.g., via a PCell 124A) in accordance with an MN configuration.

Later in time, the MN 104A determines to configure the base station 106A as a C-SN for a conditional PSCell addition (CPA). The MN 104A can make this determination based on measurement result(s) from the UE 102, for example. In some implementations, the MN 104A can detect or estimate that the UE 102 is moving toward coverage (i.e., one or more cells) of the base station 106A based on uplink signals received from the UE 102 or positioning measurement result(s) received from the UE 102. In response to the determination, the MN 104A sends 304 a connectivity message to add and/or change connectivity to the C-SN 106A, such as an SN Addition Request message (e.g., SgNB Addition Request or S-Node Addition Request message). The connectivity message can include an information element identifying the type of message, such as a Conditional PSCell Addition Information Request IE. In some implementations, the Conditional PSCell Addition Information Request IE further includes a CPAC indicator to indicate CPAC-initiation and an IE to indicate a maximum number of PSCells (e.g., a Maximum Number of PSCells to Prepare IE/field). The MN 104A can generate candidate cell information including the measurement result(s) of the one or more cells and include the candidate cell information in the connectivity request message. Furthermore, the MN 104A can determine SN restriction information to restrict configuration parameters and/or values of configuration parameters that the C-SN 106A can configure for the UE 102. The MN 104A can include the SN restriction information in the connectivity request message. The MN 104A may determine MN restriction information to restrict configuration parameters and/or values of configuration parameters that the MN 104A can configure for the UE 102 when determining the SN restriction information.

In response to receiving 304 the connectivity request message with the CPAC indication, the C-SN 106A determines 306 one or more C-PSCells (C-PSCell(s)) and generates an inter-node RRC message candidate list (e.g., CG-CandidateList) to include one or more C-SN configurations, where each C-SN configuration is associated with a particular C-PSCell in the C-PSCell(s), for the UE 102. For example, the C-PSCells may be the cell 126A and the cell 126C. In some implementations, the C-SN 106A determines the C-PSCell(s) and the C-SN configuration(s) taking into account the candidate cell information and the SN restriction information. The candidate list includes an addition list of candidate IEs (e.g., CG-CandidateInfo IE(s)) which each corresponds to a C-PSCell. Each candidate IE in the addition list includes C-PSCell information for a C-PSCell (e.g., SSB frequency information (e.g., ARFCN-ValueNR) and the physical Cell ID (PCI) or Cell Global ID (CGI)) and an SCG configuration IE (e.g., a CG-Config IE). Each configuration IE includes a C-SN configuration for a corresponding C-PSCell and optional parameters for the MN to prepare conditional (re)configuration(s). In some implementations, each candidate IE includes a candidate ID (e.g., a CG-CandidateInfo ID such as a cg-CandidateInfold or CG-CandidateInfold) which identifies each candidate IE or an SCG configuration IE in each candidate IE.

In some implementations, the C-SN 106A and/or the MN 104A use the candidate IE(s) for management of the candidate IE(s) in the addition list. The C-SN 106A transmits 308 a connectivity request acknowledgement message (e.g., SgNB Addition Request Acknowledge or S-Node Addition Request Acknowledge message), including the candidate list, in an SN to MN container (e.g., SgNB to MeNB Container or S-NG-RAN node to M-NG-RAN node Container) or a CPAC container. The CPAC container is a separate RRC container included in, for example, an acknowledgement IE (e.g., a Conditional PSCell Addition Information Acknowledge IE) in the acknowledgement message to the MN 104A. In further implementations, the C-SN 106A generates coordination information and includes the coordination information in the connectivity request acknowledgement message. In some implementations, the coordination information includes one or more coordination parameters.

In some implementations, the C-SN 106A can include the one or more coordination parameters in the SCG configuration(s) in the candidate list and/or the connectivity request acknowledgement message. For example, the coordination information can include coordination parameters such as a resource coordination IE (e.g., a Resource Coordination Info IE such as SgNB Resource Coordination Information IE or MR-DC Resource Coordination Information IE) associated with a particular C-PSCell, one or more power coordination parameters (e.g., powerCoordination-FR1 and/or powerCoordination-FR2), a discontinuous reception (DRX) configuration (e.g., DRX-Info or DRX-Info2), etc. The coordination information can include coordination information for each of the C-PSCell(s). In some implementations, the C-SN 106A includes SN restriction information in the connectivity request acknowledgement message, which the MN 104A may use to determine the MN restriction information. The events 304, 306, 308 collectively define a conditional SN addition preparation procedure 392.

To allow the C-SN 106A to configure multiple C-SN configurations as described above, the MN 104A can set the IE indicating a maximum number of PSCells to a value larger than one. In cases where the MN 104A only allows the C-SN 106A to configure a single C-SN configuration, the MN 104A can set the IE indicating a maximum number of PSCells to a value equal to one.

After receiving 308 the connectivity request acknowledgement message including the candidate list, the MN 104A can assign a particular configuration ID (e.g., CondReconfigId or CondReconfigurationId) for each of the C-SN configuration(s) in the SCG configuration IE(s). For example, in cases where the SCG configuration IE(s) include the C-SN configurations 1 . . . . N (N is an integer larger than zero), the MN 104A can assign configuration ID 1 . . . . N for the C-SN configurations 1, . . . . N, respectively. In such cases, the MN 104A can include the configuration ID 1 . . . . N in the RRC reconfiguration message. In some such implementations, the MN 104A includes, in the RRC reconfiguration, trigger condition configurations 1, . . . , N for the C-SN configurations 1 . . . . N, respectively. The MN 104A can generate the trigger condition configurations. Depending on the implementation, each of the trigger condition configurations can configure one or more conditions which triggers the UE 102 to connect to the C-SN 106A via a particular C-PSCell configured in a particular C-SN configuration. In some implementations, the MN 104A generates conditional (re)configuration fields/IEs (e.g., CondReconfigurationToAddMod IEs or CondReconfigToAddMod IEs) 1 . . . . N, including the C-SN configurations 1 . . . , N, the configuration IDs (e.g., CondReconfigurationId IE or CondReconfigId IE) 1, . . . . N, and the trigger condition configurations 1 . . . . N, respectively, and transmits 312 the RRC reconfiguration message including the conditional (re)configuration fields/IEs to the UE 102. In other implementations, the MN 104A generates RRC container messages (e.g., RRCConnectionReconfiguration messages or RRCReconfiguration messages) 1 . . . . N including the C-SN configurations 1, . . . . N, respectively, generate conditional (re)configuration fields/IEs (e.g., CondReconfigurationToAddMod IEs or CondReconfigToAddMod IEs) 1, . . . . N including the RRC container messages 1 . . . , N, the configuration IDs (e.g., CondReconfigurationId IE or CondReconfigId IE) 1, . . . , N, and the trigger condition configurations 1 . . . . N, respectively, and transmits 312 the RRC reconfiguration message including the conditional (re)configuration fields/IEs to the UE 102.

The MN 104A may include the C-SN configuration(s) in an RRC reconfiguration message (e.g., RRCConnectionReconfiguration message or RRCReconfiguration message), and transmits 312 the RRC reconfiguration message to the UE 102. In response, the UE 102 transmits 314 an RRC reconfiguration complete message (e.g., RRCConnectionReconfiguration Complete message or RRCReconfiguration Complete message) to the MN 104A. The events 312 and 314 collectively define a RRC reconfiguration procedure 310.

In some implementations, the MN 104A transmits an SN message (e.g., SN Reconfiguration Complete message) to the C-SN 106A to indicate that the UE 102 receives the C-SN configuration(s). Depending on the implementation, the MN 104A transmits the message in response to or after receiving the RRC reconfiguration complete message. In other implementations, the MN 104A refrains from sending an SN message to the C-SN 106 to indicate the UE 102 receives the C-SN configuration(s). Events 304, 306, 308, 312 and 314 collectively define a conditional SN addition preparation procedure 390 which includes the RRC reconfiguration steps not covered in 392.

In cases where the MN 104A and/or the C-SN 106A reconfigure a bearer type of a DRB from an MN-terminated bearer to an SN-terminated bearer in the conditional SN addition preparation 392, the MN 104A can transmit 316 a message to indicate an initial status (e.g., an Early Status Transfer message) to the C-MN 104A. For example, the C-SN 106A can include, in the SCG configuration IE(s), a radio bearer configuration (e.g., RadioBearerConfig IE) reconfiguring a bearer type of the DRB from the MN-terminated bearer to the SN-terminated bearer. The MN 104A retrieves the radio bearer configuration from the SCG configuration IE(s) and includes the radio bearer configuration in the RRC container message(s). In the status message, the MN 104A can include a DL COUNT value of the first downlink SDU that the MN 104A forwards to the C-SN 106A, or a DL COUNT value for discarding of already forwarded downlink SDUs for the DRB of the UE 102. The MN 104A can do so after receiving 314 the RRC reconfiguration complete message or an acknowledgement (e.g., RLC acknowledgement or hybrid automatic repeat request (HARQ) acknowledgement) for a PDU (e.g., RLC PDU or MAC PDU) including the RRC reconfiguration message. In some implementations, the MN 104A sends 316 the statusmessage without receiving an interface message indicating that the UE 102 connects to the C-SN 106A. In cases where no bearer type change from the MN-terminated bearer to the SN-terminated bearer occurs and/or is configured in the SCG configuration IE(s), the MN 104A may refrain from transmitting a status message to the C-SN 106A.

In some implementations, the UE 102 uses the one or more conditions to determine whether to connect to the one of the C-PSCell(s). If the UE 102 detects 318 that a condition for connecting to a C-PSCell is satisfied, the UE 102 connects to the C-PSCell. That is, the condition (or “triggering condition”) triggers the UE 102 to connect to the C-PSCell or to execute the C-SN configuration concerning the C-PSCell. In further implementations, if the UE 102 does not detect that the condition is satisfied, the UE 102 does not connect to the C-PSCell. In response to the detection, the UE 102 initiates a random access procedure on the C-PSCell. In response to the initiation, the UE 102 performs 320 the random access procedure with the C-SN 106A via the C-PSCell. In response to the detection or initiation 318, the UE 102 sends 322 an RRC reconfiguration complete message to the MN 104A. Depending on the implementation, the UE 102 sends 322 the RRC reconfiguration complete message before, during, or after the random access procedure.

In some implementations, the UE 102 indicates, in the RRC reconfiguration complete message, that the UE 102 has executed one of the C-SN configuration(s) by including a configuration ID corresponding to the particular C-SN configuration. The MN 104A can use the configuration ID to identify or determine the ID of the C-PSCell (e.g., the PCI and/or the CGI of the C-PSCell) and/or the C-SN if the MN 104A performs multiple CPA procedures with different C-SNs. The MN 104A can also use the configuration ID to identify or determine the C-SN configuration or the SCG configuration including the C-SN configuration.

In response to or after receiving 322 the RRC reconfiguration complete message, the MN 104A can send 324 an SN message to the C-SN 106A. In some implementations, the SN message can be a reconfiguration completion message, such as an SgNB Reconfiguration Complete or S-Node Reconfiguration Complete message. In other implementations, the SN message can be a radio resource message, such as an RRC Transfer message. In yet other implementations, the SN message can be a new interface message (e.g., XnAP or X2AP message) defined in 3GPP 38.423 or 36.423 release 17 specification. In some implementations, the UE 102 can include an SN RRC message (e.g., RRCReconfigurationComplete message) in the RRC reconfiguration complete message that the UE 102 transmits at event 322. In such cases, the MN 104A can include the SN RRC message in the SN message.

In some implementations, the random access procedure is a four-step random access procedure or a two-step random access procedure. In other implementations, the random access procedure is a contention-based random access procedure or a contention-free random access procedure. For example, the UE 102 may include RRC reconfiguration complete message in a message 3 of the four-step random access procedure or in a message A of the two-step random access procedure.

In some implementations, after the C-SN 106A successfully completes the random access procedure with the UE 102, the C-SN 106A transmits 326 an interface message (e.g., SN Modification Required message, an NG-RAN node Configuration Update message, a E-UTRA—NR Cell Resource Coordination Request message, or a success indication message) which may include PSCell information of PSCell and/or the corresponding CG-Config and/or coordination information (e.g., SgNB Resource Coordination Information IE or MR-DC Resource Coordination Information IE) for Physical Resource Block (PRB) coordination to the MN 104A. The PSCell information can include a cell global identity (CGI), a physical cell identity (PCI), and/or an absolute radio frequency channel number (ARFCN) identifying a DL carrier frequency of the PSCell. In some implementations, the C-SN 106A sends 326 the interface message in response to or after receiving the SN message or performing 320 the random access procedure. In some implementations, the interface message further includes SN restriction information. In some such implementations, the MN 104A uses the SN restriction information to determine the MN restriction information.

In response to or after receiving 322 the RRC reconfiguration complete message or 326 the interface message, the MN 104A applies 328 the coordination information and/or the MN restriction information. In response to applying 328 the coordination information and/or the MN restriction information, the MN 104A may transmit 330 an RRC reconfiguration message including configuration parameters to the UE 102. In some implementations, the configuration parameters 330 reconfigures or releases configuration parameters and/or values of configuration parameters that the UE 102 uses to communicate with the MN 104A. In other implementations, the configuration parameters 330 may be new configuration parameters to configure the UE 102 to communicate with the MN 104A. In response to the RRC reconfiguration message 330, the UE 102 can transmit 332 an RRC reconfiguration message to the MN 104A. In further implementations, the MN 104A, in response, transmits 334 a message to confirm the modification (e.g., SgNB Modification Confirm or S-Node Modification Confirm message). The events 320, 322, 324, 326, 328, 330, 332 and 334 are collectively referred to in FIG. 3A as a conditional SN addition execution procedure 394.

In response to or after receiving 322 the RRC reconfiguration complete message or 326 the interface message, the MN 104A can send 336 a status message to transfer uplink PDCP SN and HFN receiver status and/or downlink PDCP SN and HFN transmitter status for each of DRB(s) of the UE 102. In contrast to event 316, the MN 104A sends 336 a (non-early) status message (e.g., an SN Status Transfer message).

In some implementations, after the UE 102 successfully completes 320 the random access procedure, the UE 102 communicates 338 with the MN 104A and with the C-SN 106A via the C-PSCell in accordance with the C-SN configuration configuring the C-PSCell.

With continued reference to FIG. 3A, the C-SN configuration in some implementations can be a complete and self-contained configuration (i.e., a full configuration). The C-SN configuration may include a full configuration indication (an information element (IE) or a field) that identifies the C-SN configuration as a full configuration. The UE 102 in some such cases uses the C-SN configuration to communicate with the SN 106A without relying on an SN configuration. In other cases, the C-SN configuration includes a “delta” configuration, or one or more configurations that augment a previously received SN configuration. In some such cases, the UE 102 uses the delta C-SN configuration together with the SN configuration to communicate with the C-SN 106A.

In some implementations, the C-SN configuration includes multiple configuration parameters for the UE 102 to apply when communicating with the SN 106A via a C-PSCell. The multiple configuration parameters may configure the C-PSCell and zero, one, or more candidate secondary cells (C-SCells) of the SN 106A to the UE 102. The multiple configuration parameters may configure radio resources for the UE 102 to communicate with the C-SN 106A via the C-PSCell and zero, one, or more C-SCells of the C-SN 106A. The multiple configuration parameters may configure zero, one, or more radio bearers. The one or more radio bearers can include an SRB and/or one or more DRBs.

In some implementations, the C-SN configuration includes a group configuration (CellGroupConfig) IE that configures the C-PSCell and zero, one, or more C-SCells of the C-SN 106A. In one implementation, the C-SN configuration includes a radio bearer configuration. In another implementation, the C-SN configuration does not include a radio bearer configuration. For example, the radio bearer configuration can be a RadioBearerConfig IE, DRB-ToAddModList IE or SRB-ToAddModList IE, DRB-ToAddMod IE or SRB-ToAddMod IE. In various implementations, the C-SN configuration can be an RRCReconfiguration message, RRCReconfiguration-IEs, or the CellGroupConfig IE conforming to 3GPP TS 38.331. The full configuration indication may be a field or an IE conforming to 3GPP TS 38.331. In other implementations, the C-SN configuration can include an SCG-ConfigPartSCG-r12 IE that configures the C-PSCell and zero, one, or more C-SCells of the C-SN 106A. In some implementations, the C-SN configuration is an RRCConnectionReconfiguration message, RRCConnectionReconfiguration-IEs, or the ConfigPartSCG-r12 IE conforming to 3GPP TS 36.331. The full configuration indication may be a field or an IE conforming to 3GPP TS 36.331.

Still referring to FIG. 3A, the base station 106A (i.e., the C-SN) in some cases includes the CU 172 and one or more DUs 174 as illustrated in FIG. 1C. For each of the C-SN configuration(s), the one or more DUs 174 can generate the C-SN configuration. Alternatively, for each of the C-SN configuration(s), the one or more DUs 174 can generate a portion of the C-SN configuration and the CU 172 may generate the rest of the C-SN configuration. For example, the UE 102 performs 320 the random access procedure with the first DU 174A operating the (C-)PSCell and the first DU 174A may identify the UE 102 in the random access procedure. In some such cases, the UE 102 communicates 338 with the SN 106A via the first DU 174A.

The first DU 174A of the C-SN 106A operating the C-PSCell may generate the C-SN configuration configuring the C-PSCell or a portion of the C-SN configuration and send the C-SN configuration or the portion of the C-SN configuration to the CU 172. In cases where the first DU 174 generates a portion of the C-SN configuration, the CU 172 generates the rest of the C-SN configuration. In some implementations, the first DU 174A generates each of the other C-SN configuration(s). Alternatively, for each of the other C-SN configuration(s), the first DU 174A generates a portion of the C-SN configuration and the CU 172 generates the rest of the respective C-SN configuration. In other implementations, the first DU 174A generates at last one first C-SN configuration in the C-SN configuration(s). Alternatively, for each of the first C-SN configuration(s), the first DU 174A generates a portion of the C-SN configuration and the CU 172 generates the rest of the C-SN configuration. In some implementations, a second DU 174B of the C-SN 106A generates at least one second C-SN configuration in the C-SN configuration(s). In other implementations, for each of the second C-SN configuration(s), the second DU 174B generates a portion of the C-SN configuration and the CU 172 generates the rest of the C-SN configuration.

Referring next to FIG. 3B, the scenario 300B depicts an MN-initiated conditional SN change scenario where the MN 104A initially connects with an S-SN 106B and later performs a conditional change procedure with the C-SN 106A. The interactions between MN 104A and C-SN 106A are similar to those described in FIG. 3A. The differences between FIG. 3B and FIG. 3A are described below.

The UE 102 is initially in dual connectivity 301 with MN 104A and S-SN 106B and communicates with S-SN 106B via a PSCell in accordance with S-SN configuration. Later in time, the MN 104A, C-SN 106A, and UE 102 perform the conditional SN addition preparation procedure 390. In case early data forwarding is to be utilized, the MN 104A may transmit 340 an interface message (e.g., Xn-U Address Indication or Data Address Indication message) to the S-SN 106B. The S-SN 106B then transmits 342 a status message (e.g., an Early Status Transfer message) to the MN 104A, and the MN 104A then transmits 316 the status message to the C-SN 106A.

Similar to FIG. 3A, in some implementations the UE 102 later detects 318 a condition for connecting to the C-PSCell is met and performs a random access procedure on the C-PSCell in response to the detection with the C-SN 106A. The UE 102, MN 104A, and C-SN 106A performs the conditional SN addition execution 394. The MN 104A transmits 344 a release request message (e.g., SgNB Release Request or S-Node Release Request message) to the S-SN 106B. The S-SN 106B in response transmits 346 a release request acknowledgement message (e.g., SgNB Release Request Acknowledge or S-Node Release Request Acknowledge message). In case data forwarding is to be utilized, the MN 104A may transmit 347 an interface message (e.g., Xn-U Address Indication or Data Address Indication message) to the S-SN 106B. The S-SN 106B then may transmit 348 a status message (e.g., an SN Status Transfer message) to the MN 104A and the MN 104A then may transmit 336 a similar status message to the C-SN 106A. The MN 104A transmits 350 a release message for the UE Context to the S-SN 106B. The events 344, 346, 347, 348, 336, 350 can be collectively referred as an SN release and SN status transfer procedure 396.

After the UE 102 successfully completes 320 the random access procedure, the UE 102 communicates 338 with the MN and with the SN via the C-PSCell in accordance with the C-SN configuration configuring the C-PSCell.

Referring next to FIG. 3C, the scenario 300C depicts an SN-initiated conditional SN change scenario where the MN 104A initially connects with an S-SN 106B and later is triggered by S-SN 106B to perform a conditional change procedure with the C-SN 106A. The interactions between MN 104A and C-SN 106A are similar to those described in FIG. 3A or 3B. The differences between FIG. 3C and FIGS. 3A and 3B are described below.

The S-SN 106B at some point in time decides to initiate a conditional SN change procedure and transmits 303 a message indicating that an SN change is required (e.g., SgNB Change Required or S-Node Change Required message defined in the 3GPP TS 36.423 and 38.423, respectively) including the candidate Target SN ID (e.g., Global en-gNB ID, or Global NG-RAN Node ID), and the SCG configuration, which further includes the proposed candidate cell information (e.g., physical cell ID and/or related cell measurement results) and the trigger condition(s) (e.g., condExecutionCond-SCG IE which may include measurement ID(s) referring to a configured S-SN measurement) for the corresponding candidate cell(s), to the MN 104A. The MN 104A and the C-SN 106A perform the conditional SN addition preparation procedure 392 with the proposed candidate cell information from the S-SN 106B. The MN 104A may transmit 352 an SN request message (e.g., SgNB Modification Request or S-Node Modification Request message) to provide the candidate PSCell(s) accepted by the C-SN 106A to the S-SN 106B. The S-SN 106B in response may transmit 354 an SN message acknowledging the request (e.g., SgNB Modification Request Acknowledge or S-Node Modification Request Acknowledge message) to provide the updated measurement configuration and/or trigger condition(s). The MN 104A performs 310 an RRC reconfiguration procedure with the UE 102 to configure the conditional (re)configuration(s). The MN 104A transmits 309 a confirmation message confirming the SN change (e.g., SgNB Change Confirm or S-Node Change Confirm message) to the S-SN 106B. The events 303, 392, 352, 354, 310, and 309 can be collectively referred as the SN-initiated conditional SN change preparation 393.

Depending on the implementation, if the UE 102 later detects 318 a condition for connecting to a C-PSCell is met, the UE 102 performs the random access procedure with the C-SN 106A via the C-PSCell and the conditional SN addition execution procedure 394. The MN 104A, S-SN 106B, and C-SN 106A perform the SN release and SN status transfer procedure 396. In some implementations, different from scenario 300B, the MN 104A does not transmit 344 the release request message and the S-SN 106B may therefore not transmit 346 the message acknowledging the release request.

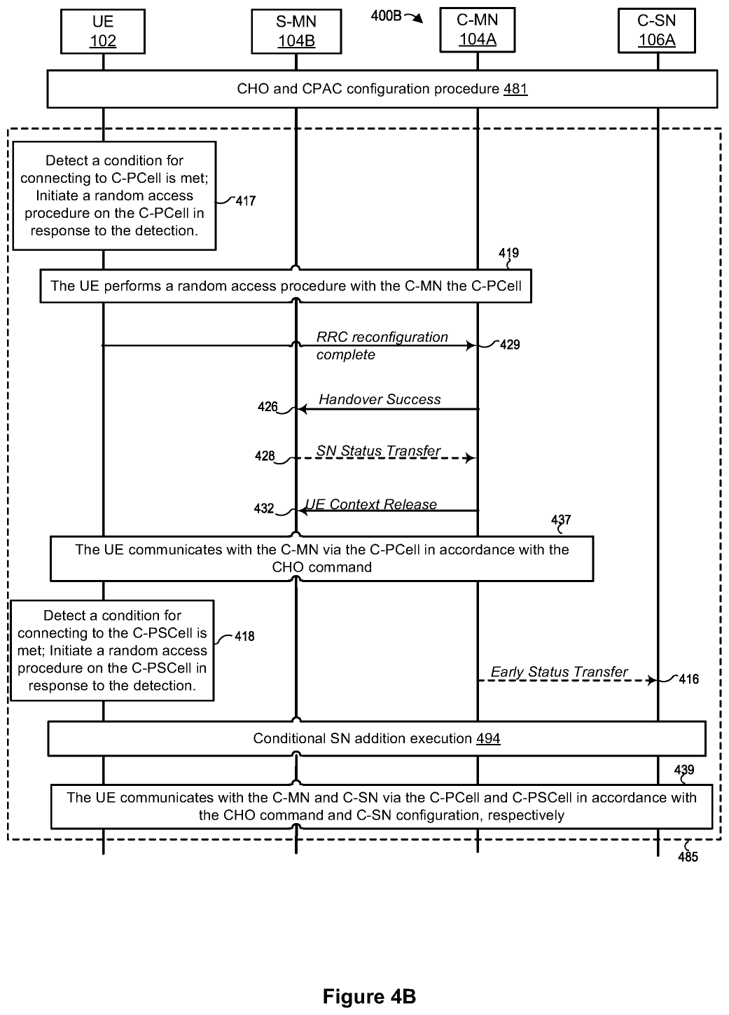

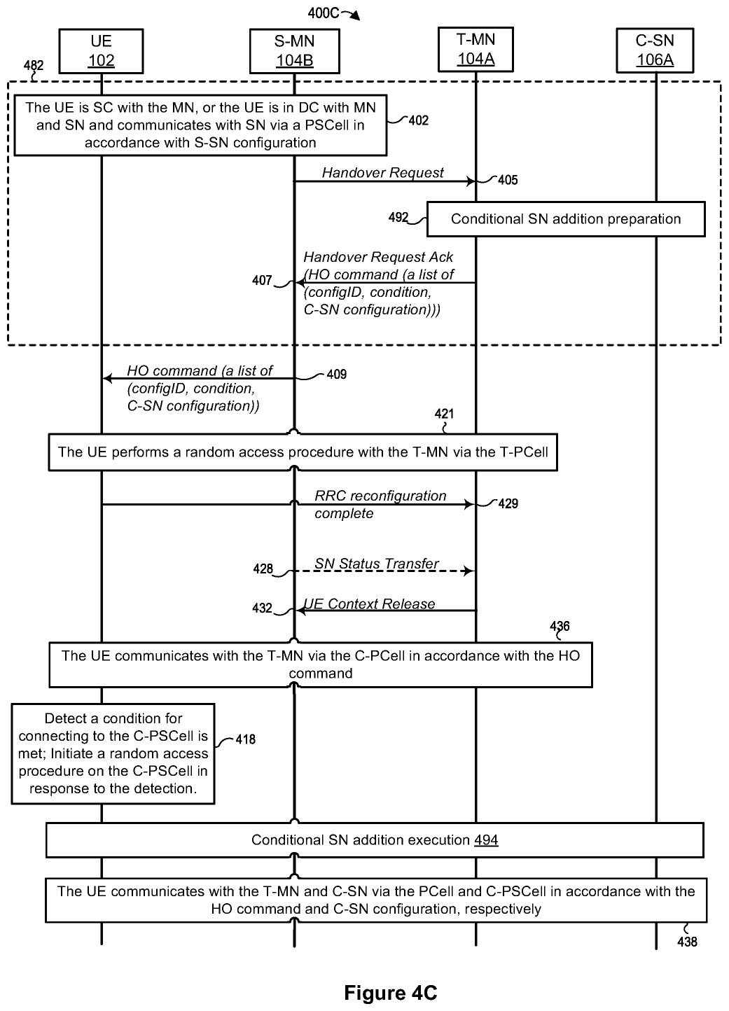

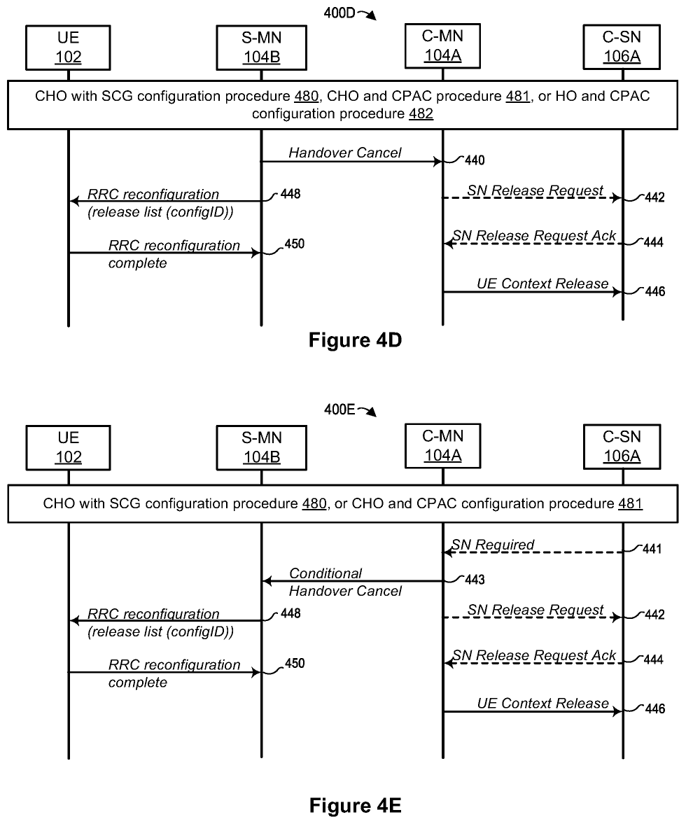

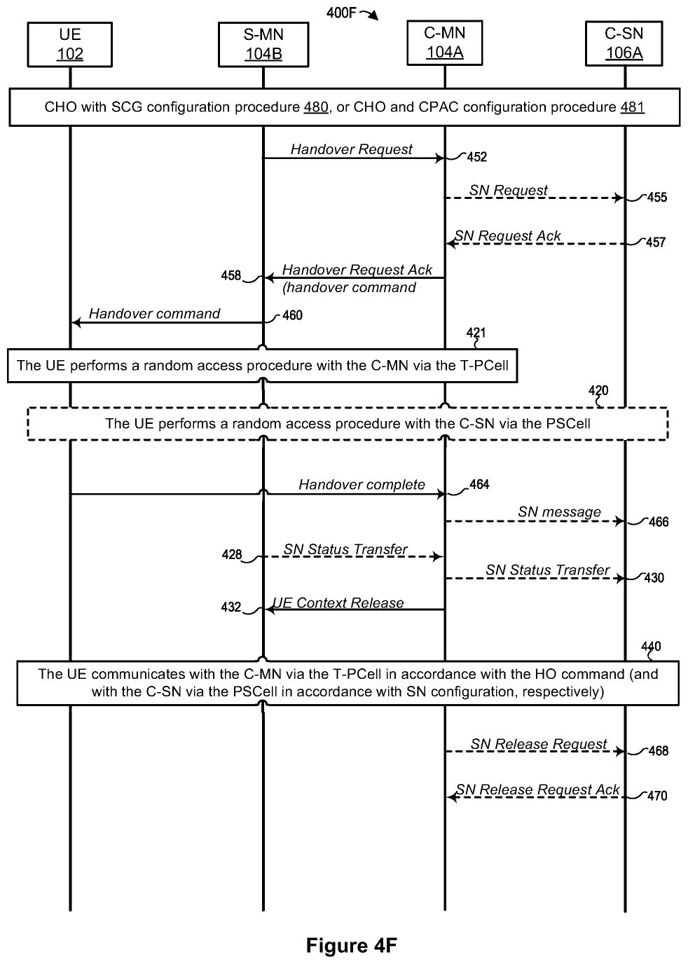

Turning to FIGS. 4A-4F, scenarios 400A to 400F may each contain some portion to be similar to any one of the scenarios 300A-300C. However, the scenarios 400A-400F involve a conditional handover with CPAC which the CPAC parts was described in scenarios 300A-300C or a conditional handover with SCG configuration which will be further elaborated below.

Referring first to FIG. 4A, in the scenario 400A, an example scenario where a conditional handover with SCG configuration is described.

The UE 102 initially either operates 402 in single connectivity (SC) with the S-MN 104B or in DC with the S-MN 104B and an S-SN (e.g., the C-SN 106A or a different base station 106B), and communicates with the S-SN via a PSCell in accordance with an S-SN configuration. The S-MN 104B at some time point decides to perform a conditional handover and transmit 404 a message requesting a handover (e.g., a Handover Request message) including a CHO indication (e.g., a Conditional Handover Information Request IE including a CHO trigger IE indicating “CHO-initiation”) and/or measurement results from the UE 102 to the C-MN 104A. The measurement results may include some candidate cell information for the C-MN 104A to consider whether to trigger an SN addition procedure. The C-MN 104A then performs 492 a conditional SN addition preparation procedure with the C-SN 106A. In some implementations, the handover request message includes the SN UE ID (e.g., SgNB UE X2AP ID or S-NG-RAN node UE XnAP ID) for the UE 102, which the C-MN 104A may further include in the connectivity request message. If the C-SN 106A is also the S-SN for the UE 102, the C-SN 106A can use the SN UE ID to identify the UE context when the C-SN 106A receives the connectivity request message from the C-MN 104A. The C-SN 106A can therefore decide to keep the UE context and notify the decision in the acknowledgement message for the connectivity request to the C-MN 104A. The C-MN 104A can provide this “UE Context Kept” decision to the S-MN 104B in the connectivity request acknowledgement message so that the S-MN 104B can further indicate to the C-SN 106A (e.g., the S-SN) to refrain from releasing the UE context in the release request message.

In some implementations, the conditional SN addition preparation procedure 492 is the same as the procedure 392 in FIG. 3A. The C-MN 104A retrieves the SCG configuration IE(s) from the candidate list IE that the C-MN 104A received in the conditional SN addition preparation procedure 492 and retrieves one or more C-SN configuration(s) from the SCG configuration IE(s). The C-MN 104A then generates a CHO command (e.g., RRC reconfiguration message) which includes one or more conditional (re)configuration IE(s) (e.g., CondReconfigurationToAddMod IEs or CondReconfigToAddMod IEs) including the one or more C-SN configuration(s) as described for FIG. 3A. Such implementations for the procedure 492 can be referred as CHO with CPAC.

In other implementations, the conditional SN addition preparation procedure 492 is similar to the procedure 392, except the MN 104A includes an IE indicating the maximum number of PSCells in the connectivity request message. and the MN 104 further sets the IE with a value equal to one in order to restrict the C-SN 106A to configuring a single SCG configuration, including a single C-SN configuration.

In yet other implementations, the conditional SN addition preparation procedure 492 is similar to the procedure 392, except the MN 104A includes a CHO indication (e.g., a separate IE indicating “CHO with SCG”) in the connectivity request message instead of a CAPC indication. In some implementations, in response to the CHO indication, the C-SN 106A only includes a single SCG configuration IE, including a single C-SN configuration, in the connectivity request acknowledgement message. In one implementation, the C-SN 106A directly includes the SCG configuration IE in an SN to MN container IE in the connectivity request acknowledgement message, instead of wrapping the SCG configuration IE with the candidate list IE and including the candidate list IE in the SN to MN container IE. The C-MN 104A retrieves the SCG configuration IE from the SN to MN container IE and retrieves the C-SN configuration from the SCG configuration IE. Alternatively, the C-SN 106A wraps the SCG configuration IE with the candidate list IE and includes the candidate list IE in the SN to MN container IE. The C-MN 104A retrieves the candidate list IE from the SN to MN container IE, retrieves the SCG configuration IE from the candidate list IE and retrieves the C-SN configuration from the SCG configuration IE. After retrieving the C-SN configuration, the C-MN 104A generates a CHO command (e.g., RRC reconfiguration message) including the C-SN configuration (e.g., within the nr-SecondaryCellGroupConfig field or mrdc-SecondaryCellGroupConfig field) without wrapping the C-SN configuration with a conditional (re)configuration IE (e.g., CondReconfigurationToAddMod IE or CondReconfigToAddMod IE). In some such implementations, the procedure 492 is referred to as a CHO with SCG configuration.

In some cases where the C-MN 104A is an eNB or ng-eNB, the CHO command or RRC reconfiguration message is a radio connection reconfiguration message (e.g., an RRCConnectionReconfiguration message). In some cases where the C-MN 104A is a gNB, the RRC reconfiguration message is an RRCReconfiguration message.

The C-MN 104A transmits 406 an acknowledgement message for a handover request (e.g., a Handover Request Acknowledge message) including the CHO command to the S-MN 104B in response to the handover requestmessage. The S-MN 104B transmits 408 an RRC reconfiguration message including the CHO command to the UE 102. More specifically, the S-MN 104B generates a conditional (re)configuration IE (e.g., CondReconfigurationToAddMod IE or CondReconfigToAddMod IE) including the CHO command and a first trigger condition configuration and includes the conditional (re)configuration IE in the RRC reconfiguration message during the event 408.

The first trigger condition configuration configures a condition that triggers the UE 102 to connect to a candidate PCell (C-PCell) of the C-MN 104A. In response to the RRC reconfiguration message, the UE 102 replies 410 with an RRC reconfiguration complete message to the S-MN 104B. In case the S-MN 104B determines that early data forwarding is to be utilized, the S-MN 104B can transmit 412 a status message (e.g., an Early Status Transfer message) to the C-MN 104A. In cases where the C-MN 104A and/or the C-SN 106A reconfigure a bearer type of a DRB from an MN-terminated bearer to an SN-terminated bearer in the conditional SN addition preparation procedure 492, the C-MN 104A may transmit 414 an initial status message (e.g., Early Status Transfer message) to the C-SN 106A. For example, the C-SN 106A can include, in the SCG configuration IE, a radio bearer configuration (e.g., RadioBeaerConfig IE) reconfiguring a bearer type of the DRB from the MN-terminated bearer to the SN-terminated bearer. The C-MN 104A retrieves the radio bearer configuration from the SCG configuration IE and includes the radio bearer configuration in the CHO command. In such cases, the C-MN 104A can retrieve a DL COUNT value received from the initial status message 412 and include the DL COUNT value in the initial status message 414.

In some cases where no bearer type change from the MN-terminate bearer to the SN-terminated bearer is configured as a result of the conditional SN addition preparation procedure 492, the C-MN 104A refrains from transmitting an initial status message to the C-SN 106A. In the scenario 400A, the CHO with SCG configuration is adopted for the procedure 492. Events 402, 404, 492, 406, 408, 410, 412, and 414 can be collectively referred to as procedure 480 including a conditional handover with SCG configuration (CHO with SCG) preparation.

In some implementations, after receiving the first condition configuration, the UE 102 evaluates whether the condition is met to determine whether to connect to the C-PCell. If the UE 102 detects 415 that the condition for connecting to a C-PCell is satisfied, the UE 102 connects to the C-PCell and the C-PSCell in response to the detection. That is, the condition (or “triggering condition”) triggers the UE 102 to connect to the C-PCell and C-PSCell or to execute the CHO command including the C-SN configuration concerning both the C-PCell and the C-PSCell. If the UE 102 does not detect that the condition is satisfied, the UE 102 does not connect to the C-PCell and the C-PSCell.

In response to the detection, the UE 102 initiates 415 a first random access procedure on the C-PCell and a second random access procedure on the C-PSCell. In response to the initiation, the UE 102 performs 419 the first random access procedure with the C-MN 104A via the C-PCell and performs 420 the second random access procedure with the C-SN 106A via the C-PSCell, respectively. In response to the detection or initiation 415, the UE 102 sends 422 an RRC reconfiguration complete message which includes an SN RRC reconfiguration complete message to the C-MN 104A. The UE 102 can send 422 the RRC reconfiguration complete message before, during, or after the first random access procedure. In response to or after receiving 422 the RRC reconfiguration complete message, the C-MN 104A transmits 424 an SN message (e.g., SN Reconfiguration Complete message) including the SN RRC reconfiguration complete message to the C-SN 106A.

After successfully completing the first random access procedure with the UE 102 receiving 422 the RRC reconfiguration message, the C-MN 104A transmits 426 a message indicating the success of the handover (e.g., a Handover Success message) to the S-MN 104B. If data forwarding is to be utilized, the S-MN 104B may transmit 428 a status message (e.g., an SN Status Transfer message) to the C-MN 104A. The C-MN 104A may transmit 430 a status message to the C-SN 106A. The C-MN 104A may further transmit 432 a message releasing a UE context (e.g., a UE Context Release message) to the S-MN 104B and the S-MN 104B initiates an SN Release procedure to the S-SN if the UE 102 was in DC in event 402. The UE 102 communicates 439 with C-MN 104A and C-SN 106A via the C-PCell and C-PSCell in accordance with CHO command and C-SN configuration, respectively. Events 415, 419, 420, 422, 424, 426, 428, 430, 432, and 439 can be collectively referred as a CHO with SCG configuration execution procedure 484.

Referring next to FIG. 4B, the scenario 400B is an example scenario similar to scenario 400A but the conditional handover is configured together with CPAC instead of the SCG configuration as specified in 400A.

Initially, the UE 102, S-MN 104B, C-MN 104A, and C-SN 106A perform a CHO and CPAC configuration procedure 481 similar to procedure 480 with differences described below. In particular, in a conditional SN addition preparation procedure in the CHO (similar to the procedure 492) and CPAC configuration procedure 481, the C-MN 104A can include a CPAC indication in a connectivity request message (e.g., an SN Addition Request message) instead of the CHO indication with SCG (as described with regard to procedure 480), similar to the event 304. Alternatively, the C-MN 104A still includes the CHO indication in the connectivity request message in addition to the CPAC indication. Depending on the implementation, the C-MN 104A might or might not restrict the C-SN 106A to configure only one C-SN configuration. In cases where the C-MN 104 allows the C-SN 106A to configure more than one C-SN configuration, the C-SN 106A can configure one or more C-SN configurations as described for FIG. 3A. For each of the C-SN configuration(s), the C-MN 104A generates conditional (re)configuration IE(s) (e.g., CondReconfigurationToAddMod IE or CondReconfigToAddMod IE), includes conditional (re)configuration field(s)/IE(s) as described for FIG. 3A, and includes the conditional (re)configuration field(s)/IE(s) in the CHO command.

Later in time, if the UE 102 detects 417 that the condition for connect to a C-PCell is satisfied in accordance with the first trigger condition configuration, the UE 102 connects to the C-PCell in response to the detection. That is, the condition (or “triggering condition”) triggers the UE 102 to connect to the C-PCell or to execute the CHO command concerning the C-PCell. In response to the detection 417, the UE 102 performs 419 the first random access procedure with the C-MN 104A via the C-PCell. In response to the detection or initiation 419, the UE 102 sends 429 an RRC reconfiguration complete message to the C-MN 104A. The UE 102 can send 429 the RRC reconfiguration complete message before, during, or after the first random access procedure. The C-MN 104A transmits 426 an indication of the successful handover (e.g., a Handover Success message) to the S-MN 104B. The S-MN 104B may transmit 428 a status message (e.g., an SN Status Transfer message) to the C-MN 104A. The C-MN 104A transmits 432 a message to release the UE context (e.g., a UE Context Release message) to the S-MN 104B. The UE 102 communicates 437 with the C-MN 104A via the C-PCell in accordance with the CHO command. The C-MN 104A may transmit 416 an initial status message (e.g., an Early Status Transfer message) to the C-SN 106A.

After executing the CHO command, the UE 102 starts to evaluate trigger condition(s) in the conditional (re)configuration field(s)/IE(s). While evaluating the trigger condition(s), the UE 102 detects 418 that a condition for connecting to the C-PSCell is met and initiates a second random access procedure on the C-PSCell in response to the detection. The UE 102 then performs 494 the conditional SN addition execution procedure with the C-MN 104A and C-SN 106A similar to the conditional SN addition execution 394. After connecting the C-PSCell, the UE 102 communicates 439 with C-MN 104A and C-SN 106A via the C-PCell and C-PSCell in accordance with CHO command and C-SN configuration, respectively. Events 417, 419, 429, 426, 428, 432, 437, 418, 416, 494 and 439 can be collectively referred as a CHO and CPAC execution procedure 485.

Referring next to FIG. 4C, in the scenario 400C, an example scenario where an immediate handover with a conditional SN addition preparation procedure is described.

The UE 102 initially either operates 402 in single connectivity (SC) with the S-MN 104B or in DC with the S-MN 104B and an S-SN (e.g., the C-SN 106A or a different base station 106B) and communicates with the S-SN via a PSCell in accordance with an S-SN configuration. The S-MN 104B at some point in time decides to transmit 405 a message requesting a handover (e.g., a Handover Request message) including a target PCell to a target MN (T-MN) 104A. The T-MN 104A performs the conditional SN addition preparation procedure 492 with the C-SN 106A as described with regard to 392 and obtains a candidate list including one or more SCG configuration IE(s). The T-MN 104A generates a handover command (e.g., RRC reconfiguration message) which also includes the conditional (re)configuration(s) including the C-SN configuration(s) as described after event 308. The T-MN 104A transmits 407 an acknowledgement of the handover request (e.g., a Handover Request Acknowledge message) including the handover command. In some cases in which the S-SN is also the C-SN 106A, the acknowledgement of the handover may also include a UE context IE (e.g., a UE Context Kept Indicator IE) to indicate that the UE context at the S-SN shall be kept after the handover procedure. The S-MN 104B transmits 409 the handover command including the conditional configuration(s) for the C-SN configuration(s) to the UE 102. Events 402, 405, 492, 407 can be collectively referred as a handover (HO) with CPAC preparation procedure 491.

In response to receiving 409 the HO command, the UE 102 performs 421 a first random access procedure via the target PCell with the T-MN 104A. The UE 102 transmits 429 an RRC reconfiguration complete message to the T-MN 104A during or after the random access procedure 421. The S-MN 104B may transmit 428 a status message (e.g., an SN Status Transfer message) to the T-MN 104A. The T-MN 104A transmits 432 a message releasing a context for the UE 102 (e.g., a UE Context Release message) to the S-MN 104B. In cases in which the UE 102 was in DC in event 402, the S-MN 104B initiates an SN release procedure with the S-SN and may indicate the UE context to be kept if requested by the T-MN 104A. After handover, the UE 102 communicates 436 with the T-MN 104A via the configured PCell in accordance with the HO command.

In some implementations, the UE 102 later detects 418 that a condition for connecting to the C-PSCell is met and, in response to the detection, initiates a second random access procedure on the C-PSCell. The UE 102, the T-MN 104A, and the C-SN 106A then perform the conditional SN addition execution procedure 494 similar to the procedure 394. The UE 102 communicates 438 with the T-MN 104A via the PCell and with the C-SN 106A via the identified C-PSCell in accordance with the HO command and the C-SN configuration, respectively.

Referring next to FIG. 4D, in the scenario 400D, an example scenario where a handover cancel procedure is initiated by the S-MN after a CHO with CPAC configuration or a handover (HO) with CPAC configuration is described.

The UE 102, S-MN 104B, C-MN (or T-MN) 104A, and C-SN 106A initially perform CHO with SCG configuration procedure 480, CHO and CPAC configuration procedure 481, or HO and CPAC configuration procedure 482 as described in FIGS. 4A, 4B, and 4C, respectively. The S-MN 104B may later transmit 440 a message canceling a handover (e.g., a Handover Cancel message) to the C-MN 104A to, for example, cancel the CHO or immediate HO preparation. In some implementations, the S-MN 104B may do so because the S-MN 104B determines that the candidate cell(s) do not qualify for CHO or immediate HO anymore. In the case of canceling the CHO preparation, the S-MN 104B also transmits 448 an RRC reconfiguration message which may include a release list (e.g., condReconfigToRemove List IE) which lists the configuration ID of the conditional configuration(s) to the UE 102. The UE 102 replies 450 an RRC reconfiguration complete message in response to the RRC reconfiguration message. The UE 102 releases the conditional (re)configuration field(s)/IE(s) indicated in the release list. The C-MN (or T-MN) 104A may transmit 442 a message requesting an SN release (e.g., an SN Release Request message) to the C-SN 106A. The C-SN 106A in response transmits 444 an acknowledgement to the request (e.g., an SN Release Request Acknowledge message) to the C-MN (or T-MN) 104A. The C-MN (or T-MN) 104A transmits 446 a message releasing a UE context (e.g., a UE Context Release message) to the C-SN 106A.

Referring next to FIG. 4E, a scenario 400E, an example scenario where a conditional handover cancel procedure is initiated by the C-MN after a CHO with CPAC configuration is described.

The UE 102, S-MN 104B, C-MN 104A, and C-SN 106A initially perform CHO with SCG configuration procedure 480 or CHO and CPAC configuration procedure 481 as described in FIGS. 4A and 4B, respectively. The C-MN 104A may later transmit 443 a message canceling a handover (e.g., a Conditional Handover Cancel message) to the S-MN 104B to cancel the CHO with CPAC preparation because the C-MN 104A detects congested traffic or errors in response to an SN required message (e.g., SN Modification Required or SN Change Required message) 441 transmitted by the C-SN 106A to the C-MN 104A. In some implementations, the C-SN 106A transmits 441 the SN nequired message to the C-MN 104A because the C-SN 106A detects congested traffic or errors. In response, the S-MN 104B transmits 448 an RRC reconfiguration message which may include a release list (e.g., condReconfigToRemove List IE), which lists the configuration ID of the conditional configuration(s) to the UE 102. The UE 102 replies 450 with an RRC reconfiguration complete message in response to the RRC reconfiguration message. In further implementations, the C-MN 104A transmits 442 a release request message (e.g., an SN Release Request message) to the C-SN 106A. The C-SN 106A in response transmits 444 an acknowledgement (e.g., an SN Release Request Acknowledge message) to the C-MN 104A. The C-MN 104A transmits 446 a message releasing a UE context (e.g., a UE Context Release message) to the C-SN 106A.

Referring next to FIG. 4F, in the scenario 400F, an example scenario where an MN initiates an immediate handover after a CHO with a conditional SN addition procedure is described.

The UE 102, S-MN 104B, C-MN 104A, and C-SN 106A initially perform a CHO with SCG configuration procedure 480, or a CHO and CPAC configuration procedure 481 as specified in FIGS. 4A and 4B, respectively. In some implementations, the UE 102 later changes a moving trajectory and provides a measurement result to the S-MN 104B. Based on the measurement result, the S-MN 104B can therefore decide to perform immediate handover preparation for the UE 102 and transmit 452 a message requesting a handover (e.g., a Handover Request message) without including a CHO indication to the C-MN 104A to initiate an immediate handover to a target PCell (T-PCell). In some implementations, the C-MN 104A determines to perform an immediate SN addition with the C-SN 106A during the immediate handover preparation. In response to the determination, the C-MN 104A transmits 455 a connectivity request message (e.g., SN Addition Request message without including a conditional indication) to the C-SN 106A. The C-SN 106A in response transmits 457 an acknowledgement (e.g., SN Addition Request Acknowledge message) including an SN configuration (e.g., SN RRC reconfiguration message) for a PSCell to the C-MN 104A. In response to the message requesting the handover, the C-MN 104A can transmit 458 an acknowledgement (e.g., a Handover Request Acknowledge message) including a handover command message (e.g., RRC reconfiguration message, which may include an SN configuration if received from the C-SN 106A in event 457) to the S-MN 104B.

The S-MN 104B in response transmits 460 the handover command message to the UE 102. In response to the handover command message, the UE 102 removes (or discards) conditional configuration(s) and performs 421 a first random access procedure with the C-MN 104A via the target PCell. If the handover command message includes the SN configuration, the UE 102 performs 420 a second random access procedure with the C-SN 106A via the PSCell in response to the SN configuration. The UE 102 transmits 464 a handover complete message (e.g., RRC reconfiguration complete message) to the C-MN 104A in response to the handover command message.

In some implementations, the UE 102 sends 464 the handover complete message before, during, or after the first random access procedure. If the handover complete message includes an SN RRC reconfiguration complete message, the C-MN 104A transmits 466 an SN message (e.g., SN Reconfiguration Complete message) including the SN RRC reconfiguration complete message to the C-SN 106A. In some implementations where data forwarding is to be used, the S-MN 104B transmits 428 a status message (e.g., an SN Status Transfer message) to the C-MN 104A. Depending on the implementation, the C-MN 104A may transmit 430 the status message to the C-SN 106A. The C-MN 104A may further transmit 432 a message to release a UE context (e.g., a UE Context Release message) to the S-MN 104B and the S-MN 104B initiates an SN release procedure with the S-SN if the UE 102 was in DC in event 402. The UE 102 communicates 440 with C-MN 104A via the target PCell in accordance with the handover command (and, if the C-SN 106A is added during the immediate handover, with the C-SN 106A via the configured PCell in accordance with the SN configuration, respectively).

In response to or after receiving 452 the handover request message, the C-MN 104A may transmit 468 an SN request (e.g., an SN Release Request (or an SN Modification Request)) message to the C-SN 106A to request that the C-SN 106A cancel all of the C-SN configuration(s) for the UE 102. In response, the C-SN 106A transmits 470 an acknowledgement (e.g., an SN Release Request Acknowledge (or SN Modification Request Acknowledge)) message. The SN request message may include the MN UE X2/XnAP ID and/or SN UE X2/XnAP ID that were included in the message(s) (e.g., SN Addition Request message and/or SN Addition Request Acknowledge message) for the conditional SN addition preparation procedure 492. The events 468 and/or 470 can occur before or after the event 455, 457, 466 or 430.

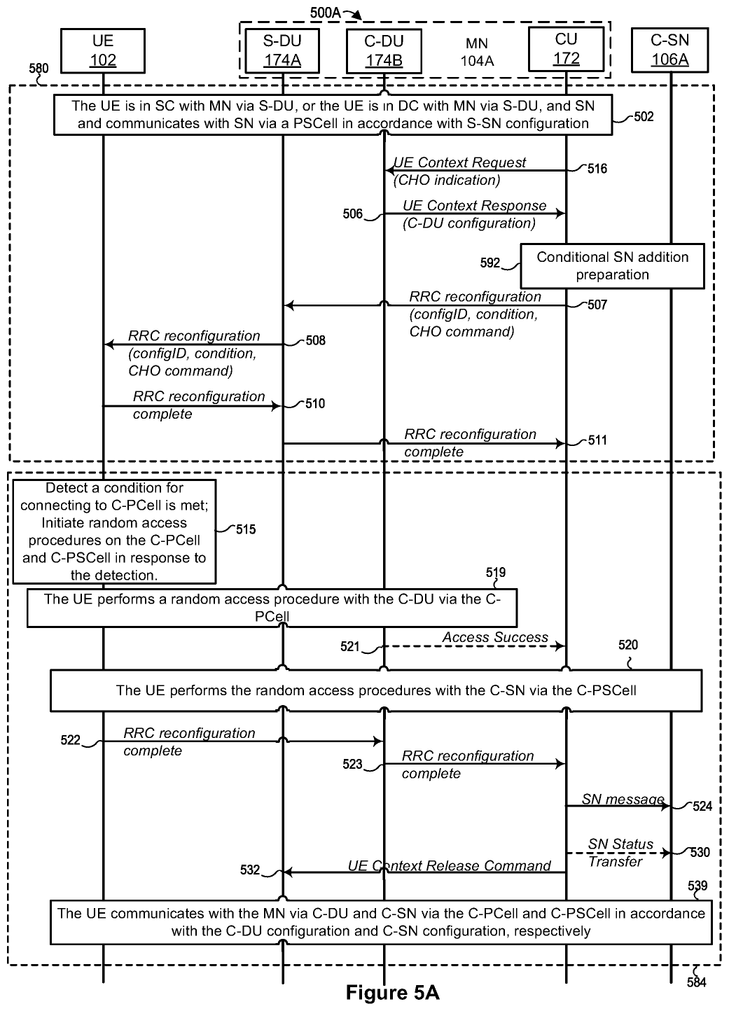

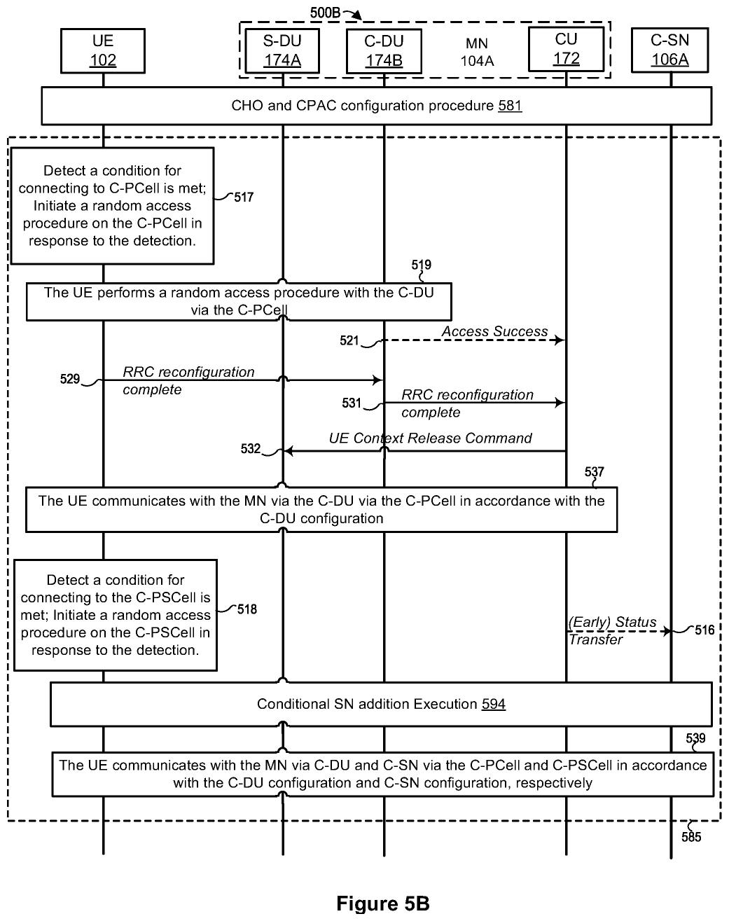

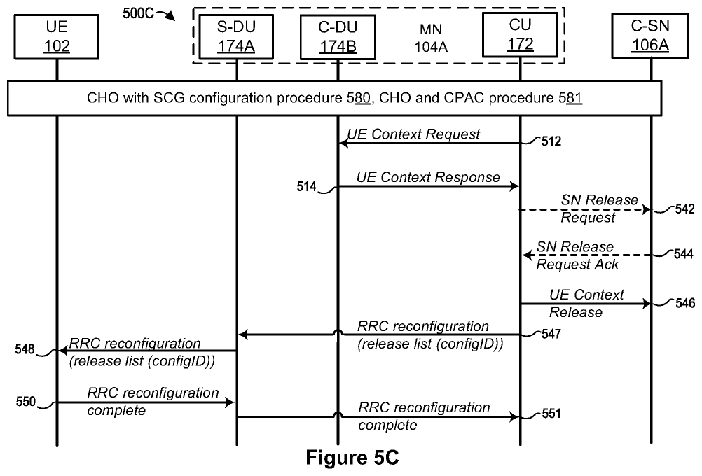

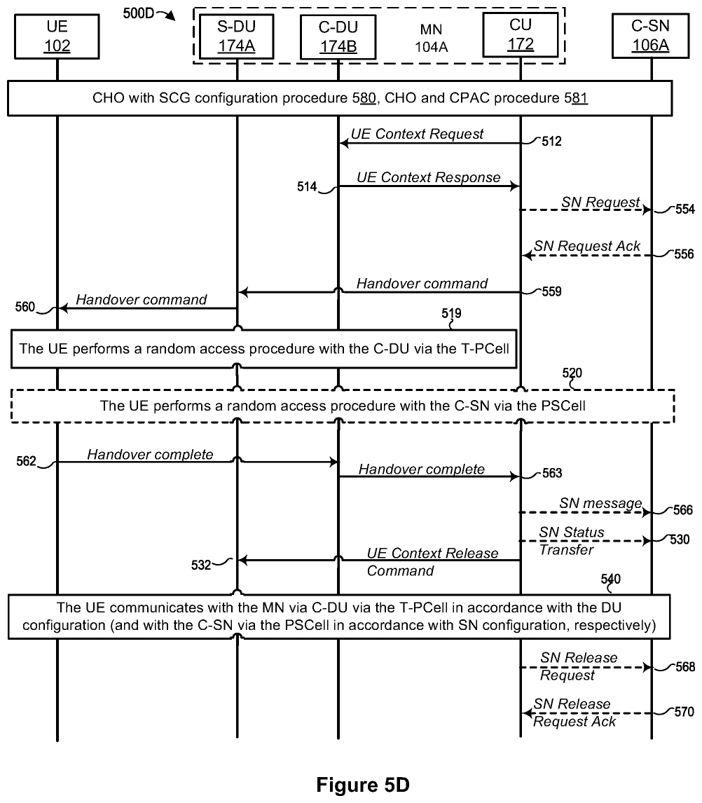

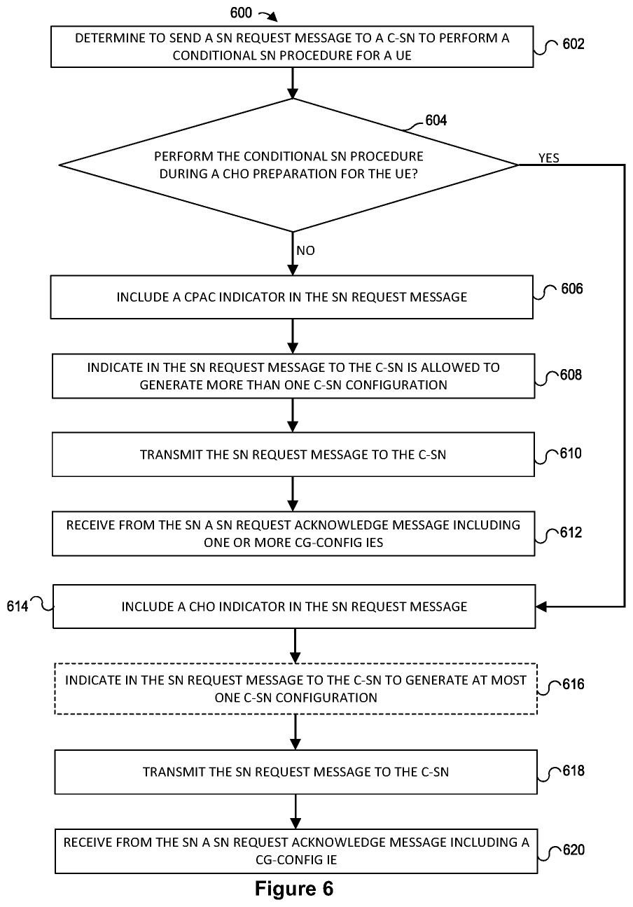

Turning to FIGS. 5A-5D, scenarios 500A-500D may each contain some portion to be similar to any one of the scenarios 300A-300C or 400A-400G. However, the scenarios 500A-500D involve an intra-base-station CHO with CPAC or a CHO with SCG configuration.

Referring first to FIG. 5A, the scenario 500A is an example scenario where the MN 104A consists of a CU 172 and one or more DU(s) such as source/serving DU (S-DU) 174A and candidate DU (C-DU) 174B, and decides to perform an intra-MN CHO with a conditional SN addition.

The UE 102 is initially in SC 502 with the MN 104A via an S-DU 174A, or in DC with the MN 104A via an S-DU 174A and an S-SN (e.g., the C-SN 106A or another base station not shown in the figure), and communicates with the S-SN via a PSCell in accordance with the S-SN configuration. The CU 172 of the MN 104A at some point in time (based on some measurement result, for example) decides to perform a conditional intra-MN handover. The CU 172 transmits 516 a message to the C-DU 174B requesting a context for the UE 102 (e.g., UE Context Setup Request) including a CHO indication (e.g., a Conditional Inter-DU Mobility Information IE including a CHO Trigger IE with value “CHO-initiation”). The C-DU 174B in response transmits 506 a response to the request (e.g., UE Context Setup Response) including a C-DU configuration. The CU 172 of the MN 104A performs 592 a conditional SN addition preparation procedure with a C-SN 106A similar to and as described with regard to the procedure 492 for CHO with SCG configuration in FIG. 4A. The CU 172 generates a CHO command including the SCG configuration for CHO with SCG configuration. The CU 172 transmits 507 an RRC reconfiguration message to the S-DU 174A including the configuration ID, trigger condition configuration, and the CHO command. In some implementations, the 507 RRC reconfiguration message is included in a DL RRC Message Transfer message. In other implementations, the RRC reconfiguration message 507 is included in a context modification request (e.g., a UE Context Modification Request message). The S-DU 174A transmits 508 the RRC reconfiguration message to the UE 102. The UE 102 replies 510 to the RRC reconfiguration message with an RRC reconfiguration complete message to the S-DU 174A. The S-DU 174A forwards 511 the RRC reconfiguration complete message to the CU 172 in an uplink or acknowledgement message (e.g., a UL RRC Message Transfer message or a UE Context Modification Request Acknowledge message). Events 502, 516, 506, 592, 507, 508, 510, and 511 can be collectively referred to as intra-MN CHO with SCG configuration preparation procedure 580.

After receiving the first condition configuration, the UE 102 evaluates whether the condition is met to determine whether to connect to the C-PCell. If the UE 102 detects 515 that the condition for connecting to a C-PCell is satisfied, the UE 102 initiates random access procedure(s) on the C-PCell and C-PSCell in response to the detection. That is, the condition (or “triggering condition”) triggers the UE 102 to connect to the C-PCell and C-PSCell or to execute the CHO command including the C-SN configuration concerning both the C-PCell and the C-PSCell. If the UE 102 does not detect that the condition is satisfied, the UE 102 does not connect to the C-PCell and the C-PSCell.

In response to the detection, the UE 102 initiates 515 a first random access procedure on the C-PCell and a second random access procedure on the C-PSCell. In response to the initiation, the UE 102 performs 519 the first random access procedure with the C-DU 174B via the C-PCell and performs 520 the second random access procedure with the C-SN 106A via the C-PSCell, respectively. In some implementations, after successfully completing the first random access procedure with the UE 102, the C-DU 174B transmits 521 to the CU 172 an indication of success (e.g., an Access Success message) including a Cell ID for the C-PCell. In response to the detection or initiation 515, the UE 102 sends 522 an RRC reconfiguration complete message which also includes an SN RRC reconfiguration complete message to the MN 104A via the C-DU 174B. The C-DU 174B further forwards 523 the RRC reconfiguration complete message in an uplink message (e.g., a UL RRC Message Transfer message). The RRC reconfiguration complete message also includes an SN RRC reconfiguration complete message in to the CU 172. The UE 102 can send 522 the RRC reconfiguration complete message before, during, or after the first random access procedure.

In response to sending 522 the RRC reconfiguration complete message with the embedded SN RRC reconfiguration complete message, the MN 104A (or the CU 172 of the MN 104A) transmits 524 an SN message (e.g., SN Reconfiguration Complete message) including the SN RRC reconfiguration complete message to the C-SN 106A. In some implementations in which data forwarding is to be utilized, the MN 104A (or the CU 172 of the MN 104A) transmits 530 a status message (e.g., an SN Status Transfer message) to the C-SN 106A. Depending on the implementation, the CU 172 may further transmit 532 a context release message (e.g., a UE Context Release Command message) to the S-DU 174A and the S-DU 174A transmits a completion message (e.g., a UE Context Release Complete message) in response. The MN 104A may initiate an SN release procedure with the S-SN if the UE 102 was in DC in event 502 and the S-SN is different from the C-SN 106A. The UE 102 communicates 539 with the MN 104A and C-SN 106A via the C-PCell serving by the C-DU 174B and C-PSCell in accordance with the C-DU configuration and C-SN configuration, respectively. Events 515, 519, 520, 521, 522, 523, 524, 530, 532 and 539 can be collectively referred to as an intra-MN CHO with SCG execution procedure 584.

Referring next to FIG. 5B, the scenario 500B is an example scenario similar to scenario 500A but the conditional handover is configured together with CPAC configuration instead of SCG configuration.

Initially, the UE 102, MN 104A (S-DU 174A, C-DU 174B, CU 172), and C-SN 106A perform an intra-MN CHO and CPAC configuration procedure 581 similar to procedure 580 as described with regard to FIG. 5A above, with differences described below. In particular, in a conditional SN addition preparation procedure in the CHO (similar to the procedure 592 or 492) and CPAC configuration procedure 581, the CU 172 can include a CPAC indication in a connectivity request message (e.g., an SN Addition Request message) instead of the CHO indication with SCG (as described with regard to procedure 480 or 580), similar to the event 304. Alternatively, the CU 172 still includes the CHO indication in the connectivity request message in addition to the CPAC indication. Depending on the implementation, the CU 172 might or might not restrict the C-SN 106A to configure only one C-SN configuration. In cases where the CU 172 allows the C-SN 106A to configure more than one C-SN configuration, the C-SN 106A can configure one or more C-SN configurations as described for FIG. 3A. For each of the C-SN configuration(s), the CU 172 generates conditional (re)configuration IE (e.g., CondReconfigurationToAddMod IE or CondReconfigToAddMod IE), includes conditional (re)configuration field(s)/IE(s) as described for FIG. 3A, and includes the conditional (re)configuration field(s)/IE(s) in the CHO command.

Later in time, if the UE 102 detects 517 that the condition for connecting to a C-PCell is satisfied in accordance with the first trigger condition configuration, the UE 102 initiates a first random access procedure on the C-PCell in response to the detection. That is, the condition (or “triggering condition”) triggers the UE 102 to connect to the C-PCell or to execute the CHO command concerning the C-PCell. In response to the detection 517, the UE 102 performs 519 the first random access procedure with the C-DU 174B via the C-PCell. After successfully completing the first random access procedure with the UE 102, the C-DU 174B may transmit 521 to the CU 172 an indication of success (e.g., an Access Success message) including a Cell ID for the C-PCell. In response to the detection or initiation 517, the UE 102 sends 529 an RRC reconfiguration complete message to the MN 104A via the C-DU 174B. The C-DU 174B further forwards 531 the RRC reconfiguration complete message to the CU 172 in an uplink radio resource message (e.g., a UL RRC Message Transfer message). The UE 102 can send 529 the RRC reconfiguration complete message before, during, or after the first random access procedure. The CU 172 may further transmit 532 a context release message (e.g., a UE Context Release Command message) to the S-DU 174A and the S-DU 174A transmits a message confirming the completion (e.g., a UE Context Release Complete message) in response. The UE 102 communicates 537 with the MN 104A via the C-DU 174B via the C-PCell in accordance with the C-DU configuration.

After executing the CHO command (including the C-DU configuration), the UE 102 starts to evaluate trigger condition(s) in the conditional (re)configuration field(s)/IE. While evaluating the trigger condition(s), the UE 102 detects 518 that a condition for connecting to the C-PSCell is met and initiates a second random access procedure on the C-PSCell in response to the detection. The UE 102 then performs the conditional SN addition execution procedure 594 with the C-DU 174B, CU 172 and C-SN 106A, similar to the conditional SN addition execution procedure 394 in FIG. 3A and procedure 494 in FIG. 4B. The UE 102 communicates 539 with the MN 104A and C-SN 106A via the C-PCell serving by the C-DU 174B and C-PSCell in accordance with the C-DU configuration and C-SN configuration, respectively. Events 517, 519, 521, 529, 531, 532, 537, 516, 518, 594, and 539 can be collectively referred as an intra-MN CHO with CPAC execution procedure 585.

Referring next to FIG. 5C, in the scenario 500C, an example scenario where an MN initially performed an intra-MN CHO with CPAC configuration preparation and later decides to cancel (some or all) the conditional configuration preparation(s) is described.

The UE 102, S-DU 174A, C-DU 174B, CU 172, and C-SN 106A initially perform the CHO with SCG configuration preparation procedure 580 or the CHO and CPAC configuration procedure 581 as described in FIGS. 5A and 5B, respectively. The CU 172 may later transmit 512 a request for a UE context (e.g., a UE Context Request message) to the C-DU 174B which may indicate the C-DU configuration(s) to be cancelled. In some implementations, the CU 172 transmits 512 the request because the CU 172 determines that the C-PCell(s) do not qualify for CHO anymore. In response, the C-DU 174B transmits 514 a response (e.g., a UE Context Response message) to the CU 172. Depending on the implementation, the CU 172 may transmit 542 a request to release an SN (e.g., an SN Release Request message) to the C-SN 106A. The C-SN 106A in response transmits 544 an acknowledgement (e.g., an SN Release Request Acknowledge message) to the CU 172. The CU 172 transmits 546 a context release message (e.g., a UE Context Release message) to the C-SN 106A. The CU 172 generates an RRC reconfiguration message including a release list (e.g., condReconfigToRemoveList field or condReconfigurationToRemoveList field) which includes the configuration ID(s) for the conditional configuration(s) to be released. The CU 172 transmits 547 a CU-to-DU message (e.g., DL RRC Message Transfer message or a UE Context Modification Request message) including the RRC reconfiguration message to the S-DU 174A. The S-DU 174A retrieves the RRC reconfiguration message from the CU-to-DU message and transmits 548 the RRC reconfiguration message to the UE 102. The UE 102 transmits 550 an RRC reconfiguration complete message to the S-DU 174A in response to the RRC reconfiguration message. The S-DU 174A transmits 551 a DU-to-CU message (e.g., a UL RRC Message Transfer message or a UE Context Modification Response message) including the RRC reconfiguration complete message to the CU 172.

In some implementations, the context request response messages in events 512 and 514 are a release command (e.g., UE Context Release Command message) and a completion notification (e.g., UE Context Release Complete message), respectively. In other implementations, the UE Context Request message and UE Context Response message in events 512 and 514 are a modification request (e.g., UE Context Modification Request message) and response (e.g., UE Context Modification Response message), respectively.

Referring next to FIG. 5D, in the scenario 500D, an example scenario where an MN initiates an immediate intra-MN handover after an intra-MN CHO with a conditional SN addition procedure is described.

Initially, the UE 102, S-DU 174A, C-DU 174B, CU 172, and C-SN 106A perform the CHO with SCG configuration preparation procedure 580 or the CHO and CPAC configuration procedure 581 as described in FIGS. 5A and 5B, respectively. In some implementations, the UE 102 later changes a moving trajectory and provides a measurement result to the CU 172. Based on the measurement result, the CU 172 may therefore decide to perform immediate handover preparation for the UE 102 and transmit 512 a request for a UE context (e.g., UE Context Setup Request message) without including a conditional indication (e.g., CHO indication) to the C-DU 174B for the immediate handover preparation. In response, the C-DU 174B transmits a response (e.g., a UE Context Response message such as a UE Context Setup Response message) including a DU configuration for a target PCell to the CU 172. In some implementations, the CU 172 determines to perform an immediate SN addition with the C-SN 106A during the immediate handover preparation. In response to the determination, the CU 172 transmits 554 a connectivity request (e.g., an SN Request message such as an SN Addition Request message) without including a conditional indication (e.g., CPAC indication) to the C-SN 106A. The C-SN 106A in response transmits 556 an acknowledgement (e.g., SN Addition Request Acknowledge) including an SN configuration (e.g., SN RRC reconfiguration message) for a PSCell to the CU 172. The CU 172 can generate a handover command message (e.g., a RRC reconfiguration message) including the DU configuration and may include an SN configuration if received from the C-SN 106A in event 556.

The CU 172 transmits 559 a CU-to-DU message (e.g., a DL RRC Message Transfer message) including the handover command message to the S-DU 174A. The S-DU 174A retrieves the handover command message from the CU-to-DU message and transmits 560 the handover command message to the UE 102. In response to the RRC reconfiguration message, the UE 102 removes or discards all the configured conditional configuration(s) and performs 519 a first random access procedure with the C-DU 174B via the target PCell. If the handover command message also includes the SN configuration, the UE 102 performs 520 a second random access procedure with the C-SN 106A via the PSCell. The UE 102 transmits 562 a handover complete message (e.g., RRC reconfiguration complete message) to the C-DU 174B in response to the handover command message.

Depending on the implementation, the UE 102 sends 562 the RRC reconfiguration complete message before, during, or after the (first) random access procedure. The C-DU 174B sends the RRC reconfiguration complete message to the CU 172 in an uplink radio resource message (e.g., a UL RRC Message Transfer message). If the handover complete message includes an SN RRC reconfiguration complete message, the CU 172 transmits 566 an SN message (e.g., SN Reconfiguration Complete message) including the SN RRC reconfiguration complete message to the C-SN 106A. In some implementations in which data forwarding is to be used, the CU 172 transmits 530 a status message (e.g., an SN Status Transfer message) to the C-SN 106A. The CU 172 may further transmit 532 a context release message (e.g., a UE Context Release Command message) to the S-DU 174A, and the S-DU 174A, in response, transmit an indication of completion (e.g., a UE Context Release Complete message) to the CU 172. The UE 102 communicates 540 with MN 104A via the C-DU 174B via the target PCell in accordance with the DU configuration (and, if the C-SN 106A is added during the immediate intra-MN handover, with the C-SN 106A via the PSCell in accordance with the SN configuration, respectively).

Depending on the implementation, the CU 172 may transmit 568 an SN request message (e.g., an SN Release Request or SN Modification Request message) to the C-SN 106A to request the C-SN 106A to cancel all of the C-SN configuration(s). The C-SN 106A, in response, transmits 570 an acknowledgement (e.g., an SN Release Request Acknowledge or SN Modification Request Acknowledge message). The SN request message may include the MN UE X2/XnAP ID and/or SN UE X2/XnAP ID that were included in the message(s) (e.g., SN Addition Request message and/or SN Addition Request Acknowledge message) of the conditional SN addition preparation procedure 592. The events 568 and/or 570 can occur before or after the event 554, 556, 566 or 430.

FIGS. 6-12 are flow diagrams depicting example methods that a base station (e.g., the base station 104A, 104B, 106A, or 106B) can implement to support conditional procedures in accordance with the techniques of this disclosure. As indicated at various points throughout this disclosure, the example methods depicted in FIGS. 6-12 may be implemented during the scenarios 300A-300C, 400A-400G, and 500A-500E described above.

Referring to FIG. 6, a method 600 where an MN (e.g., the MN 104A or C-MN 104A) performs a conditional SN procedure with a C-SN (e.g., the C-SN 106A) for a UE (e.g., the UE 102) and determines whether to include a CPAC indicator or CHO indicator in an SN Request message.

During the method 600, the MN at block 602 determines to send an SN Request message (e.g., SN Addition Request or SN Modification Request message) to a C-SN to perform a conditional SN procedure for a UE. At block 604, the MN determines whether the conditional SN procedure is performed during a CHO preparation for the UE. If the conditional SN procedure is performed during a CHO preparation, the flow proceeds to block 614 where the MN includes a CHO indicator in the SN Request message. The flow then continues to proceed to block 616, the MN may indicate in the SN Request message to the C-SN to generate at most one C-SN configuration. At block 618, the MN transmits the SN Request message to the C-SN (e.g., event 455, 492, 554 or 592). At block 620, the MN receives from the SN an acknowledgement message (e.g., SN Addition Request Acknowledge or SN Modification Request Acknowledge message) including a configuration IE (e.g., event 457, 492, 556 or 592).

To indicate to the C-SN to generate at most one C-SN configuration in block 616, the RAN node in some implementations can include an indication of a maximum number of PSCells (e.g., a Maximum Number of PSCells to Prepare IE) with a value equal to one in the SN Request message. Alternatively, the RAN node refrains from including the indication in the SN Request message. In further implementations, the RAN node includes a candidate cell information list in the SN Request message, and the candidate cell information list indicates only one cell of the C-SN that qualifies to be a C-PSCell. For example, the candidate cell information list includes measurement results indicating only one cell of the C-SN that qualifies to be a C-PSCell.

At block 604, if the conditional SN procedure is not performed during a CHO preparation, the flow proceeds to block 606 where the MN includes a CPAC indicator in the SN request message. At block 608, the MN indicates in the SN Request message to the C-SN is allowed to generate more than one C-SN configuration. In some implementations of block 608, the RAN node can include an indication of a maximum number of PSCells with a value larger than one. The MN at block 610 transmits the SN request message to the C-SN (e.g., event 304). The MN at block 612 receives from the SN an acknowledgement (e.g., SN Addition Request Acknowledge or SN Modification Request Acknowledge message) message including one or more configuration IEs (e.g., event 308).

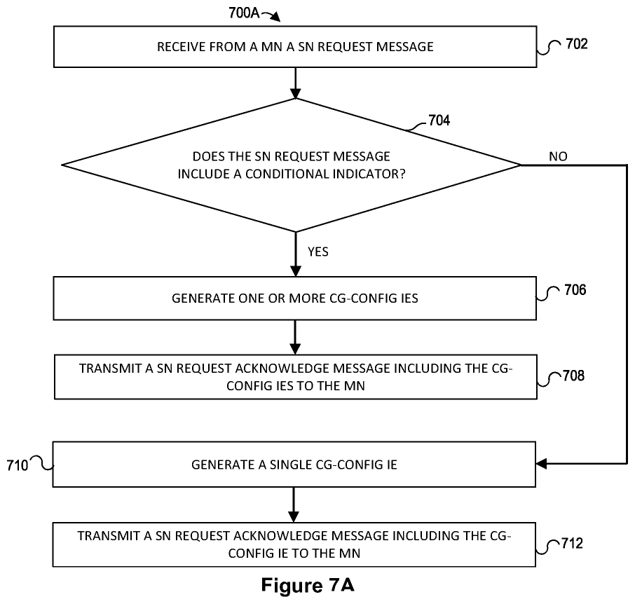

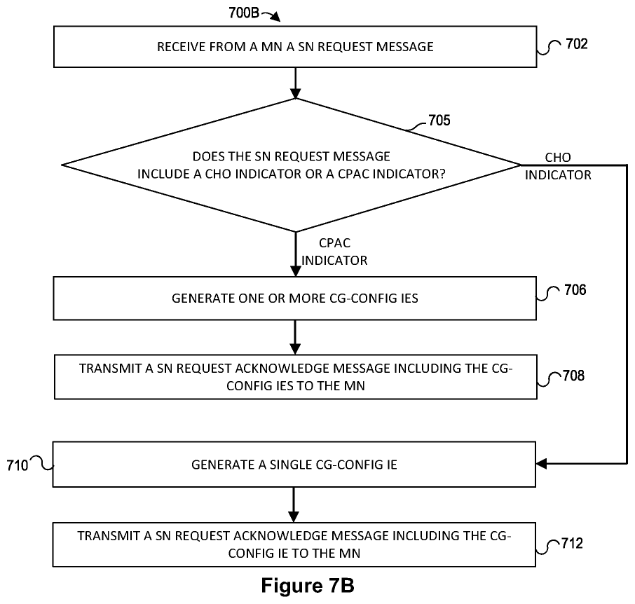

Referring next to FIG. 7A, a method 700A is illustrated where an SN (e.g., the C-SN 106A) performs a conditional SN procedure with an MN (e.g., the MN 104A or C-MN 104A) for a UE (e.g., the UE 102) and determines whether to generate one or more configuration IE(s).

During the method 700A, the SN at block 702 receives from an MN an SN request message (e.g., SN Addition Request or SN Modification Request message) (e.g., event 304, 492, 455, 554 or 592). At block 704, the SN determines whether the SN request message includes a conditional indicator. If the SN request message includes a conditional indicator, the flow proceeds to block 706 where the SN generates one or more configuration IEs (e.g., CG-Config IEs). Then at block 708, the SN transmits an acknowledgement message (e.g., SN Addition Request Acknowledge or SN Modification Request Acknowledge message) including the configuration IEs to the MN (e.g., event 308, 492, 457, 556 or 592). If the SN request message does not include a conditional indicator, the flow proceeds to block 710 where the SN generates a single configuration IE. Then at block 712 the SN transmits an acknowledgement message including the configuration IE to the MN.

In some implementations, the SN request message at block 702 includes a CPAC indicator. In other implementations, the SN request message at block 702 includes a CHO indicator.

In some implementations, the RAN node at block 706 generates a container including the one or more configuration IEs and includes the container in the acknowledgement message at block 708. In some implementations, the RAN node at block 710 refrains from generating a container in which to include the configuration IE and directly includes the configuration IE in the acknowledgement message.

In some implementations, the container is a cg-CandidateList field, cg-CandidateList field-r17. CG-CandidateList-IEs IE, CG-CandidateList-r17 IE, cg-CandidateToAddModList field, cg-CandidateToAddModList field-r17, CG-CandidateToAddModList-r17 IE.

Referring next to FIG. 7B, a method 700B is illustrated where an SN (e.g., the C-SN 106A) performs a conditional SN procedure with an MN (e.g., the MN 104A or C-MN 104A) for a UE (e.g., the UE 102) and determines whether to generate one or more configuration IE(s).

During the method 700B, the SN at block 702 receives from an MN an SN Request message (e.g., SN Addition Request or SN Modification Request message) (e.g., event 304, 492, 455, 554, or 592). At block 705, the SN determines whether the SN request message includes a CHO indicator or a CPAC indicator. If the SN request message includes a CPAC indicator, the flow proceeds to block 706 where the SN generates one or more CG-Config IEs. Then at block 708, the SN transmits an acknowledgement message (e.g., SN Addition Request Acknowledge or SN Modification Request Acknowledge message) including the CG-Config IEs to the MN (e.g., event 308). If the SN request message includes a CHO indicator at block 705, the flow proceeds to block 710 where the SN generates a single configuration IE. Then at block 712 the SN transmits an acknowledgement message including the configuration IE to the MN (e.g., event 457, 492, 556, or 592).

In some implementations, the RAN node at block 706 generates a first container including the one or more configuration IEs and includes the container in the acknowledgement message at block 708. In some implementations, the RAN node at block 710 generates a second container including the single configuration IE and includes the container IE in the acknowledgement message at block 712. In other implementations, the RAN node at block 710 refrains from generating a container in which to include the configuration IE and directly include the configuration IE in the acknowledgement message.

In some implementations, the first container is a cg-CandidateList field, cg-CandidateList field-r17, CG-CandidateList-IEs IE, CG-CandidateList-r17 IE, cg-CandidateToAddModList field, cg-CandidateToAddModList field-r17, CG-CandidateToAddModList-r17 IE. In some implementations, the second container is a cg-CandidateList field, cg-CandidateList field-r17, CG-CandidateList-IEs IE, CG-CandidateList-r17 IE, cg-CandidateToAddModList field, cg-CandidateToAddModList field-r17, CG-CandidateToAddModList-r17 IE.

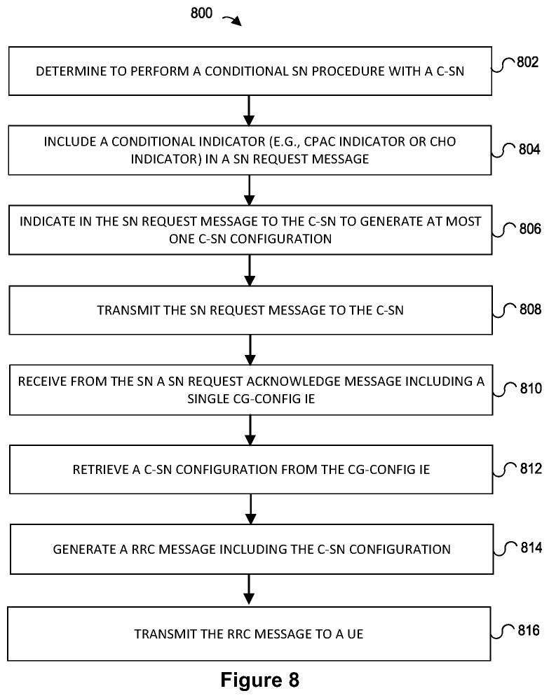

Referring to FIG. 8, a method 800 is illustrated where an MN (e.g., the MN 104A or C-MN 104A) performs a conditional SN procedure with a C-SN (e.g., the C-SN 106A) for a UE (e.g., the UE 102) and indicates the C-SN to generate at most one C-SN configuration.

During method 800, the MN at block 802 determines to perform a conditional SN procedure with a C-SN. At block 804, the MN includes a conditional indicator (e.g., CPAC indicator or CHO indicator) in an SN request message (e.g., SN Addition Request or SN Modification Request message). At block 806, the MN indicates in the SN request message to the C-SN to generate at most one C-SN configuration. The MN at block 808 transmits the SN request message to the C-SN (e.g., event 304, 455, 492, 554, or 592). The MN at block 810 receives from the SN an acknowledgement message (e.g., SN Addition Request Acknowledge or SN Modification Request Acknowledge message) including a single configuration IE (e.g., event 308, 457, 492, 556, or 592). The MN at block 812 retrieves a C-SN configuration from the configuration IE. The MN at block 814 generates an RRC message including the C-SN configuration. The MN at block 816 transmit the RRC message to a UE (e.g., event 312, 406-408, 407-409, 458-460, 507-508, or 559-560).

In cases where the RAN node is a CU of an MN, the CU transmits the RRC message to the UE via a DU. In cases where the RAN node is a C-MN, the RRC message is a CHO command and the C-MN transmits the CHO command to the UE via a source base station. In cases where the RAN node is a T-MN, the RRC message is a HO command and the T-MN transmits the HO command to the UE via a source base station.

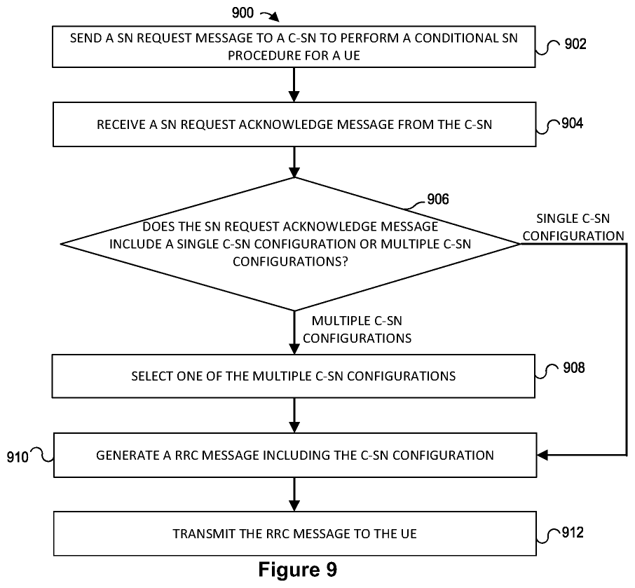

Referring to FIG. 9, a method 900 is illustrated where an MN (e.g., the MN 104A or C-MN 104A) performs a conditional SN procedure with a C-SN (e.g., the C-SN 106A) for a UE (e.g., the UE 102) and determines to generate an RRC message including one C-SN configuration.

During method 900, the MN at block 902 sends an SN request message (e.g., SN Addition Request or SN Modification Request message) to a C-SN to perform a conditional SN procedure for a UE (e.g., event 304, 492, 455, 554, or 592). The MN at block 904 receives an acknowledgement message (e.g., SN Addition Request Acknowledge or SN Modification Request Acknowledge message) from the C-SN (e.g., event 308, 492, 457, 556, or 592). At block 906, the MN determines whether the acknowledgement message includes a single C-SN configuration or multiple C-SN configurations. If the acknowledgement message includes multiple C-SN configurations, the flow proceeds to block 908 where the MN selects one of the multiple C-SN configurations. The MN at block 910 generates an RRC message including the C-SN configuration. The MN at block 912 transmits the RRC message to the UE (e.g., event 312, 406-408, 407-409, 458-460, 507-508, or 559-560). If the acknowledgement message includes a single C-SN configuration at block 906, the flow proceeds to block 910 where the MN generates an RRC message including the C-SN configuration. The MN at block 912 transmits the RRC message to the UE (e.g., event 312, 406-408, 407-409, 458-460, 507-508, or 559-560).

In some implementations, the SN request message includes a CPAC indicator. In other implementations, the SN request message includes a CHO indicator.

In cases where the RAN node is a CU of a MN, the CU transmits the RRC message to the UE via a DU. In cases where the RAN node is a C-MN, the RRC message is a CHO command and the C-MN transmits the CHO command to the UE via a source base station. In cases where the RAN node is a T-MN, the RRC message is a HO command and the T-MN transmits the HO command to the UE via a source base station.

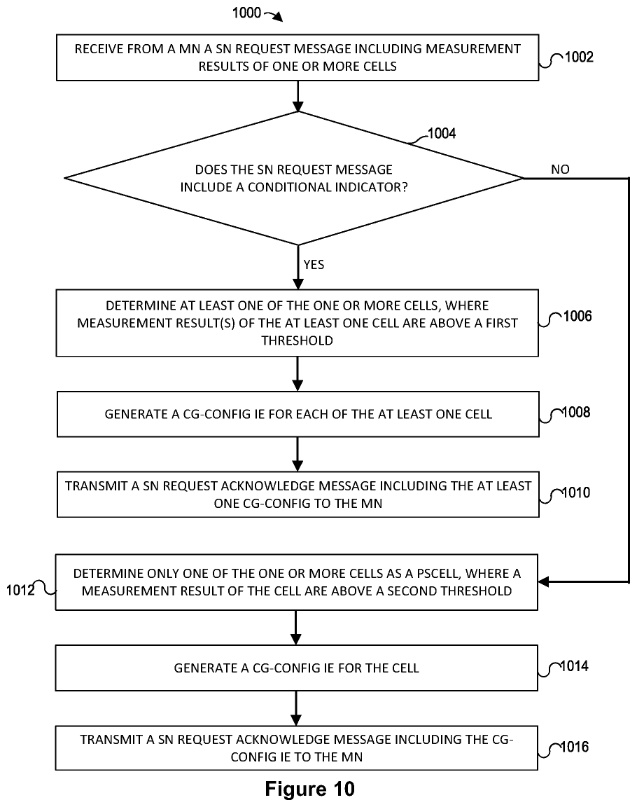

Referring next to FIG. 10, a method 1000 is illustrated where an SN (e.g., the C-SN 106A) performs a (conditional) SN procedure with an MN (e.g., the MN 104A or C-MN 104A) for a UE (e.g., the UE 102) and determines whether to generate one or more configuration IE(s).

During method 1000, the SN at block 1002 receives an SN request message (e.g., SN Addition Request or SN Modification Request message) from an MN, the message including measurement results of one or more cells (e.g., event 304, 492, 455, 554 or 592). The SN at block 1004 determines whether the SN request message includes a conditional indicator. If the SN request message includes a conditional indicator, the flow proceeds to block 1006 where the SN determines at least one of the one or more cells, where measurement result(s) of the at least one cell are above a first threshold. The SN at block 1008 generates a configuration IE (e.g., CG-Config IE) for each cell. The SN at block 1010 transmits an acknowledgement message (e.g., SN Addition Request Acknowledge or SN Modification Request Acknowledge message) including the at least one configuration IE to the MN (e.g., event 308, 492, 457, 556 or 592). If the SN request message does not include a conditional indicator at block 1004, the flow proceeds to block 1012 where the SN determines only one of the one or more cells as a PSCell, where a measurement result of the cell are above a second threshold. At block 1014, the SN generates a configuration IE for the cell. The SN at block 1016 transmits an acknowledgement message (e.g., SN Addition Request Acknowledge or SN Modification Request Acknowledge message) including the configuration IE to the MN (e.g., event 308, 492, 456, 556 or 592).

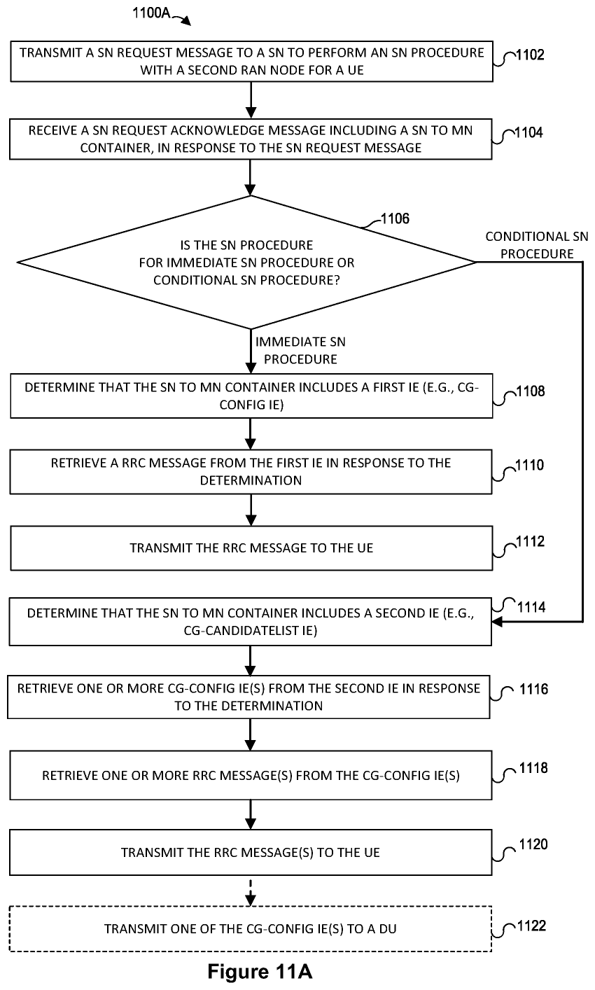

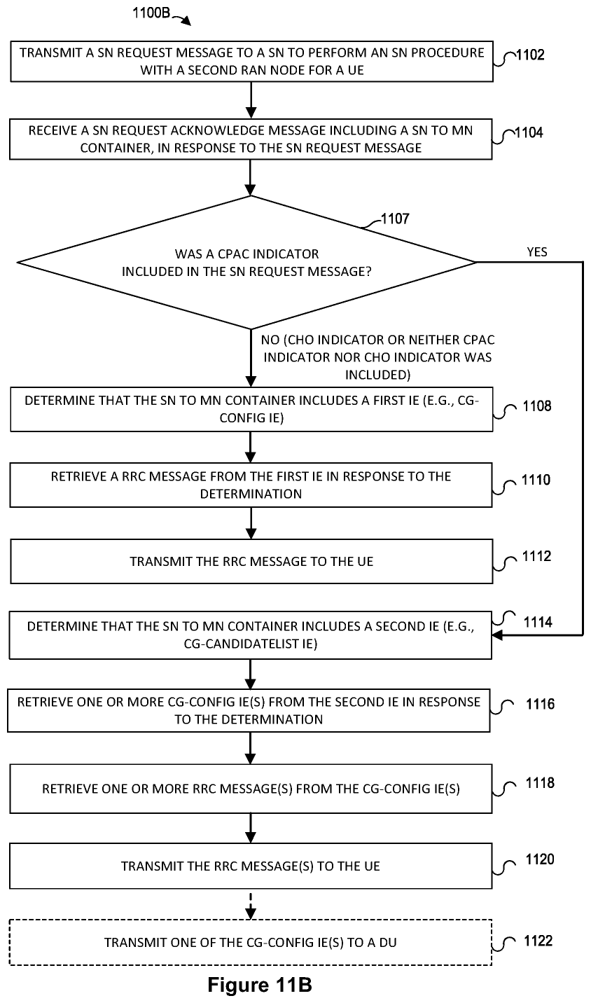

Referring to FIG. 11A, a method 1100A is illustrated where an MN (e.g., the MN or C-MN 104A) performs a conditional SN procedure with an SN (e.g., the C-SN 106A) for a UE (e.g., the UE 102) and determines how to retrieve RRC message(s) from an acknowledgement message.

During method 1100A, the MN at block 1102 transmits an SN request message (e.g., SN Addition Request or SN Modification Request message) to an SN to perform an SN procedure with a second RAN node for a UE (e.g., event 304, 492, 455, 554 or 592). The MN at block 1104 receives an acknowledgement message (e.g., SN Addition Request Acknowledge or SN Modification Request Acknowledge message) including an SN to MN container, in response to the SN request message (e.g., event 308, 492, 457, 556 or 592). The MN at block 1106 determines whether the SN procedure is for an immediate SN procedure or a conditional SN procedure. If the SN procedure is for an immediate SN procedure, the flow proceeds to block 1108 where the MN determines that the SN to MN container includes a first IE (e.g., CG-Config IE). The MN at block 1110 retrieves an RRC message from the first IE in response to the determination. The MN at block 1112 transmits the RRC message to the UE. If, at block 1106, the SN procedure is for a conditional SN procedure, the flow proceeds to block 1114 where the MN determines that the SN to MN container includes a second IE (e.g., CG-CandidateList IE). At block 1116, the MN retrieves one or more configuration IE(s) (e.g., CG-Config IE(s)) from the second IE in response to the determination. At block 1118, the MN retrieves one or more RRC message(s) from the configuration IE(s). The MN at block 1120 the MN transmit the RRC message(s) to the UE (e.g., event 312, 406-408, 407-409, 458-460, 507-508, or 559-560). The MN (or the CU of the MN) at block 1122 may transmit one of the configuration IE(s) to a DU.

Referring to FIG. 11B, a method 1100B is illustrated where an MN (e.g., the MN 104A or C-MN 104A) performs a conditional SN procedure with an SN (e.g., the C-SN 106A) for a UE (e.g., the UE 102) and determines how to retrieve RRC message(s) from an acknowledgement message.

During method 1100B, the MN at block 1102 transmits an SN request message (e.g., SN Addition Request or SN Modification Request message) to an SN to perform an SN procedure with a second RAN node for a UE (e.g., event 304, 492, 455, 554 or 592). The MN at block 1104 receives an acknowledgement message (e.g., SN Addition Request Acknowledge or SN Modification Request Acknowledge message), including an SN to MN container, in response to the SN Request message (e.g., event 308, 492, 457, 556 or 592). The MN at block 1107 determines whether a CPAC indicator was included in the SN request message. If a CPAC indicator was not included in the SN request message (i.e., a CHO indicator was included or neither CPAC indicator nor CHO indicator was included), the flow proceeds to block 1108 where the MN determines that the SN to MN container includes a first IE (e.g., CG-Config IE). The MN at block 1110 retrieves an RRC message from the first IE in response to the determination. The MN at block 1112 transmits the RRC message to the UE. If, at block 1107, a CPAC indicator was included in the SN Request message, the flow proceeds to block 1114 where the MN determines that the SN to MN container includes a second IE (e.g., CG-CandidateList IE). At block 1116, the MN retrieves one or more configuration IE(s) (e.g., CG-Config IE(s)) from the second IE in response to the determination. At block 1118, the MN retrieves one or more RRC message(s) from the configuration IE(s). The MN at block 1120 the MN transmit the RRC message(s) to the UE (e.g., event 312, 406-408, 407-409, 458-460, 507-508, or 559-560). The MN (or the CU of the MN) at block 1122 may transmit one of the configuration IE(s) to a DU.

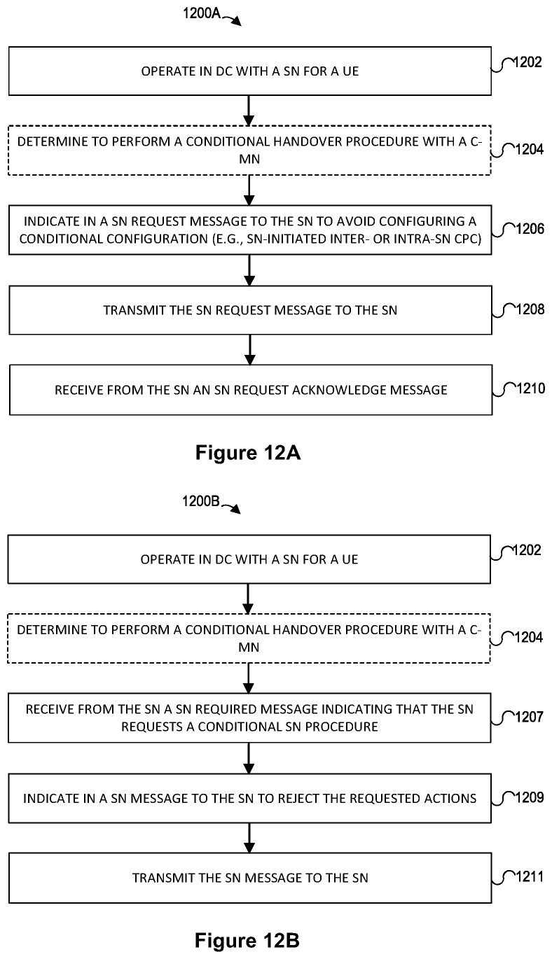

Referring to FIG. 12A, a method 1200A is illustrated where an MN (e.g., the MN 104A) performs an SN procedure with an SN (e.g., the S-SN 106B) for a UE (e.g., the UE 102) to prevent the SN from performing a conditional SN procedure.

During method 1200A, the MN at block 1202 operates in DC with an SN. At block 1204, the MN may determine to perform a conditional handover procedure with a C-MN. The MN at block 1206 indicates in an SN request message to the SN to avoid configuring a conditional configuration (e.g., SN-initiated inter- or intra-SN CPC). The MN at block 1208 transmits the SN request message to the SN. At block 1210, the MN receives an acknowledgement message (e.g., an SN Request Acknowledge message) from the SN.

In some implementations, the SN avoids configuring a conditional configuration after receiving the SN request message (e.g., SN Addition Request message or SN Modification Request message).

Referring to FIG. 12B, a method 1200B is illustrated where an MN (e.g., the MN 104A) performs an SN procedure with an SN (e.g., the S-SN 106B) for a UE (e.g., the UE 102) to prevent the SN from performing a conditional SN procedure.

During method 1200B, the MN at block 1202 operates in DC with an SN. At block 1204, the MN may determine to perform a conditional handover procedure with a C-MN. The MN at block 1207 receives, from the SN, an SN required message (e.g., SN Modification Required or SN Change Required message) indicating that the SN requests a conditional SN procedure. The MN at block 1209 indicates in an SN message (e.g., SN Modification Refuse or SN Change Refuse message) to the SN to reject the requested actions. At block 1211, the MN transmits the SN message to the SN.

In some implementations, the SN avoids configuring a conditional configuration after receiving the SN message (e.g., SN Modification Refuse or SN Change Refuse message).

The following list of examples reflects a variety of the embodiments explicitly contemplated by the present disclosure:

Example 1. A method for managing candidate cell configuration for a user equipment (UE), the method implemented in a first node and comprising: transmitting, to a second node, a request for connectivity with the second node; in response to transmitting the request for connectivity, receiving, from the second node, a response with an information element configured to include a list of configurations or a conditional configuration, the response including at least one of the list of configurations or the conditional configuration; and transmitting a radio resource message based at least on the list of configurations or the conditional configuration.

Example 2. The method of example 1, wherein the request for connectivity includes an indication that: (i) the second node has permission to generate more than one configuration for the list of configurations in the request for connectivity or (ii) the second node is to generate at most one conditional configuration, and further wherein the response includes the conditional configuration.

Example 3. The method of example 2, wherein the request for connectivity includes the indication that the second node has permission to generate more than one configuration for the list of configurations when the first node does not cause the UE to begin communications with the second node during preparation for a conditional handover.

Example 4. The method of example 2, wherein the request for connectivity includes the indication that the second node is to generate at most one conditional configuration when the first node causes the UE to begin communications with the second node during preparation for a conditional handover.

Example 5. The method of any of the preceding examples, wherein the response includes: an information element; and one of an indication for an immediate secondary node procedure or an indication for a conditional secondary node procedure.

Example 6. The method of example 5, wherein the response includes the indication for an immediate secondary node procedure, further comprising: determining, based on the indication for an immediate secondary node procedure, that the information element includes the conditional configuration; and generating, from the conditional configuration and in response to the determining, the radio resource message to be transmitted to the UE.

Example 7. The method of example 5, wherein the response includes the indication for a conditional secondary node procedure, further comprising: determining, based on the indication for a conditional secondary node procedure, that the information element includes the list of configurations; retrieving, from the information element and in response to the determining, one or more configurations in the list of configurations; and generating, from the one or more configurations, the radio resource message to be transmitted to the UE, wherein the radio resource message.

Example 8. The method of any of examples 1-4, further comprising: determining that an information element of the response includes the conditional configuration based on the request for connectivity not including a CPA indicator; and generating, from the conditional configuration and in response to the determining, the radio resource message to be transmitted to the UE.

Example 9. The method of any of examples 1-4, further comprising: determining that an information element of the response includes the list of configurations based on the request for connectivity including a CPA indicator; retrieving, from the information element and in response to the determining, one or more configurations in the list of configurations; and generating, from the one or more configurations, the radio resource message to be transmitted to the UE, wherein the radio resource message.

Example 10. The method of any of the preceding examples, further comprising: receiving, from the UE, a configuration identifier corresponding to the second node; and identifying, using the configuration identifier, at least one of: (i) an identity of the second node, (ii) an identity of a radio cell for the second node, or (iii) a configuration for the second node.

Example 11. The method of example 10, further comprising: in response to receiving the configuration identifier, transmitting a message to the second node; receiving, in response to transmitting the message to the second node, coordination information from the second node.

Example 12. The method of example 11, further comprising: modifying, using the coordination information, one or more configuration parameters for the second node; and transmitting, to the UE, the modified configuration parameters.

Example 13. The method of any of examples 1-9, wherein the UE is in dual connectivity with the first node and a third node, further comprising: receiving, from the third node, a request to transfer communication for the UE; wherein transmitting the request for connectivity is in response to receiving the request to transfer communication.

Example 14. The method of example 13, further comprising: transmitting, to the third node, a message based at least on the list of configurations or the conditional configuration.

Example 15. The method of any of examples 10-14, wherein the UE is in dual connectivity with the first node and a third node, further comprising: transmitting, to the third node, a command to release a context of the UE.

Example 16. The method of any of examples 10-15, further comprising: transmitting, to the third node, a command to release radio resources.

Example 17. The method of example 15 or 16, further comprising: receiving, from the third node, a message including status parameters of the third node; and transmitting, to the second node, the status parameters of the third node.

Example 18. The method of any of the preceding examples, further comprising: receiving an indication to perform a handover from a fourth node to the first node; and generating a handover command including the at least one of the list of configurations or the conditional configuration.

Example 19. The method of example 18, further comprising: transmitting, to the fourth node, the handover command; and communicating with the UE in accordance with the handover command.

Example 20. The method of example 18 or 19, further comprising: communicating with the UE and the second node in accordance with the command and the at least one of the list of configurations or the conditional configuration.

Example 21. The method of any of examples 18-20, wherein transmitting the radio resource message based at least on the list of configurations or the conditional configuration includes: transmitting, to the fourth node, the list of configurations or the conditional configuration and an indication to transmit the list of configurations or the conditional configuration to the UE alongside the handover command.

Example 22. The method of any of examples 18-21, wherein the handover is a conditional handover and the handover command is a conditional handover command.

Example 23. The method of any of examples 18-21, wherein the handover is an immediate handover and the handover command is an immediate handover command.

Example 24. The method of any of examples 18-23, further comprising: receiving, from the fourth node, an indication to cancel the handover; and transmitting, to the second node, an indication to release a context of the UE.

Example 25. The method of any of examples 18-23, further comprising: determining to cancel the handover; transmitting, to the fourth node, an indication to cancel the handover; and transmitting, to the second node, an indication to release a context of the UE.

Example 26. The method of example 22, further comprising: after receiving the indication to perform the conditional handover, receiving an indication to perform an immediate handover; and transmitting, to the fourth node, an immediate handover command.

Example 27. The method of example 26, further comprising: transmitting, to the second node, an indication to cancel the request for connectivity with the second node.

Example 28. The method of example 27, further comprising: transmitting, to the second node, an indication to temporarily suspend the request for connectivity with the second node.

Example 29. The method of example 1, wherein the first node comprises a first distributed unit, a second distributed unit, and a central unit.

Example 30. The method of example 29, wherein: transmitting the request for connectivity is from the central unit; receiving the response is at the central unit; and transmitting the radio resource message is from the central unit to the first distributed unit.

Example 31. The method of example 29 or 30, further comprising: transmitting, to the second distributed unit, an indication to perform a conditional handover; wherein transmitting the request for connectivity is in response to receiving the response, and further wherein the radio resource message includes a conditional handover command.

Example 32. The method of any of examples 29-31, further comprising: communicating with the UE and the second node in accordance with the conditional handover command and the at least one of the list of configurations or the conditional configuration.

Example 33. The method of example 31 or 32, further comprising: transmitting, to the first distributed unit and in response to receiving an indication from the second distributed unit that radio resource reconfiguration is complete, a command to release a context of the UE.

Example 34. The method of any of examples 31, further comprising: retrieving, from the second distributed unit, a context of the UE.

Example 35. The method of any of examples 34, further comprising: determining, based on the context of the UE, to cancel the conditional handover; and transmitting, to the first distributed unit, a command to release the conditional configuration or the list of configurations.

Example 36. The method of example 34, further comprising: determining, based on the context of the UE, to cancel the conditional handover and perform an immediate handover; and transmitting, to the first distributed unit, a command for the UE to perform the immediate handover to the second distributed unit.

Example 37. The method of example 36, further comprising: receiving, from the second distributed unit, an indication that the immediate handover is complete; and transmitting, to the first distributed unit and in response to receiving the indication that the immediate handover is complete, a command to release a context for the UE.

Example 38. The method of example 37, further comprising: transmitting, to the second node, a request for the UE to begin communication with the second node in the handover procedure, wherein the command for the UE to perform the handover is in response to receiving a response to the request to add the second node in the handover procedure.

Example 39. The method of example 37 or 38, further comprising: transmitting, to the second node and in response to receiving a first indication that the handover is complete, a second indication that the handover is complete and status parameters for the second node.

Example 40. The method of any of the preceding examples, further comprising: transmitting, to the second node, a request to release radio resources for the second node.

Example 41. The method of any of the preceding examples, wherein the first node operates in dual connectivity with the second node for the UE, further comprising: transmitting, to the second node, an indication to avoid configuring a conditional configuration.

Example 42. The method of any of examples 1-40, wherein the first node operates in dual connectivity with the second node for the UE, further comprising: receiving, from the second node, a request for a conditional secondary node procedure; and transmitting, to the second node, a rejection of the request for the conditional secondary node procedure.

Example 43. A method for managing candidate cell configuration for a user equipment (UE) initially configured to operate in connectivity with a first node, the method implemented in a second node and comprising: receiving, from the first node, a request for connectivity with the second node; determining, based on the received request for connectivity, whether to include a list of configurations or a conditional configuration; and in response to the determining, transmitting, to the first node, a response including at least one of the list of configurations or the conditional configuration.

Example 44. The method of example 43, wherein the request for connectivity with the second node includes candidate cell information, and wherein the determining is based on the candidate cell information.

Example 45. The method of example 43, wherein the determining is based on whether the request for connectivity includes a conditional indicator.

Example 46. The method of example 45, wherein the request for connectivity includes the conditional indicator, further comprising: generating the list of configurations; wherein the response includes the list of configurations.

Example 47. The method of example 45, wherein the request for connectivity does not include the conditional indicator, further comprising: generating the conditional configuration; wherein the response includes the conditional configuration.

Example 48. The method of example 43, wherein the determining is based on whether the request for connectivity includes a conditional handover indicator or a conditional primary-secondary cell (PSCell) addition or change (CPAC) indicator.

Example 49. The method of example 48, wherein the request for connectivity includes the CPAC indicator, further comprising: generating the list of configurations; wherein the response includes the list of configurations.

Example 50. The method of example 48, wherein the request for connectivity includes the conditional handover indicator, further comprising: generating the conditional configuration; wherein the response includes the conditional configuration.

Example 51. The method of example 43, wherein the request for connectivity includes measurement results of one or more cells, further comprising: determining whether the request for connectivity includes a conditional indicator.

Example 52. The method of example 51, wherein the request for connectivity includes the conditional indicator, further comprising: selecting at least one cell of the one or more cells with a measurement result above a threshold; and generating the list of configurations, wherein the list of configurations includes a configuration for each of the at least one cell; wherein the response includes the list of configurations.

Example 53. The method of example 51, wherein the request for connectivity does not include the conditional indicator, further comprising: selecting one cell of the one or more cells with a measurement result of the cell above a predetermined threshold; and generating the conditional configuration based on the one cell; wherein the response includes the conditional configuration.

Example 54. A network node comprising processing hardware and configured to implement any of the preceding examples.

Example 55. A method for managing candidate cell configuration for a user equipment (UE) initially configured to operate in connectivity with a first node, the method implemented in the UE and comprising: receiving, from the first node, a radio resource message including an information element capable of containing either of a list of configurations or a conditional configuration, and containing one of the list of configurations or the conditional configuration; detecting that a condition for connecting to a second node is met, wherein the condition for connecting to the second node is in accordance with one of the list of configurations or the conditional configuration; and in response to the detecting, operating in connectivity with the second node.

Example 56. The method of example 55, wherein the radio resource message includes a handover command.

Example 57. The method of example 56, wherein the handover command is a conditional handover command, further comprising: detecting that a condition for connecting to a third node is met, wherein the condition for connecting to the third node is in accordance with the conditional handover command; in response to detecting that the condition for connecting to the third node is met, operating in connectivity with the third node; and at least temporarily suspending connectivity with the first node.

Example 58. The method of example 56, wherein the handover command is an immediate handover command, further comprising: operating in connectivity with the third node in accordance with the immediate handover command; and at least temporarily suspending connectivity with the first node.

Example 59. The method of example 56, wherein the handover command is a conditional handover command, further comprising: after receiving the conditional handover command and before a condition associated with the conditional handover command is met, receiving a command from the first node to cancel the conditional handover.

Example 60. The method of example 56, wherein the handover command is a conditional handover command, further comprising: after receiving the conditional handover command and before a condition associated with the conditional handover command is met, receiving an immediate handover command; operating in connectivity with the third node in accordance with the immediate handover command; and at least temporarily suspending connectivity with the first node.

Example 61. The method of any of examples 56-60, wherein the first node is a first distributed unit of a master node and the third node is a second distributed unit of the master node.

Example 62. A user equipment comprising processing hardware and configured to implement any of examples 55-61.

The following description may be applied to the description above.

In some implementations, “message” is used and can be replaced by “information element (IE)”. In some implementations, “IE” is used and can be replaced by “field”. In some implementations, “configuration” can be replaced by “configurations” or the configuration parameters. In some implementations, the action “transmit” is used and can be replaced by “send”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1. A method for managing candidate cell configuration for a user equipment (UE) initially in communication with at least a first node, the method implemented in a second node and comprising:
receiving, by the second node and from the first node, a request for connectivity with the second node, the request including a procedure indicator and measurement results of one or more cells; and
transmitting, by the second node to the first node and depending on the procedure indicator, one of a list of two or more conditional configurations or a single conditional configuration, the list of two or more conditional configurations or the single conditional configuration to be used by the UE.

2. The method of claim 1, wherein the procedure indicator is a conditional handover (CHO) indicator or a conditional primary-secondary cell (PSCell) addition or change (CPAC) indicator.

3. The method of claim 2, the method further comprising:
including the list of two or more conditional configurations when the procedure indicator is the CPAC indicator.

4. The method of claim 2, wherein the request for connectivity includes the CHO indicator, the method further comprising:
generating the single conditional configuration;
wherein the transmitting comprises transmitting the single conditional configuration.

5. The method of claim 4, the method further comprising:
selecting at least one cell of the one or more cells with a measurement result above a threshold; and
generating the list of two or more conditional configurations, wherein the list of two or more conditional configurations includes a configuration for each cell of the at least one cell;
wherein the transmitting includes transmitting the list of two or more conditional configurations.

6. A method for managing candidate cell configuration for a user equipment (UE) initially in communication with at least a first node, the method implemented in the first node and comprising:
transmitting, by the first node and to a second node, a request for connectivity with the second node, the request including a procedure indicator and measurement results of one or more cells;
receiving, by the first node and from the second node, a response to the request, the response causing the first node to perform a secondary node procedure and the response including an information element conveying a list of two or more conditional configurations or a single conditional configuration according to the indication; and
transmitting, by the first node to the UE, a radio resource message based at least on the list of two or more conditional configurations or the single conditional configuration.

7. The method of claim 6, wherein the procedure indicator is an indicator for at least one of (i) a conditional handover (CHO) or (ii) an addition or change for a conditional primary secondary cell (C-PSCell).

8. The method of claim 7, wherein the secondary node procedure is one of an immediate secondary node procedure or a conditional secondary node procedure.

9. The method of claim 8, the method further comprising:
determining, when the secondary node procedure is the conditional secondary node procedure, that the information element includes the list of two or more conditional configurations;
retrieving, from the information element and in response to the determining, one or more configurations in the list of two or more conditional configurations; and
generating, based on the one or more configurations, the radio resource message to be transmitted to the UE.

10. The method of claim 8, the method further comprising:
determining, when the secondary node procedure is the immediate secondary node procedure, that the information element includes the single conditional configuration; and
generating, based on the single conditional configuration, the radio resource message to be transmitted to the UE.

11. The method of claim 7, the method further comprising:
determining that the information element includes the list of two or more conditional configurations based on the request for connectivity including the indication of the addition or change for the C-PSCell; and
retrieving, from the information element and in response to the determining, one or more configurations in the list of two or more conditional configurations; and
generating, from the one or more configurations, the radio resource message to be transmitted to the UE.

12. The method of claim 7, wherein the request for connectivity includes the indication of the addition or change for the C-PSCell when the first node does not cause the UE to begin communications with the second node during preparation for a conditional handover.

13. The method of claim 7, wherein the request for connectivity includes the indication of the CHO when the first node causes the UE to begin communications with the second node during preparation for a conditional handover.

14. The method of claim 7, wherein:
the first node comprises a first distributed unit, a second distributed unit, and a central unit;
transmitting the request for connectivity is from the central unit;
receiving the response is at the central unit; and
transmitting the radio resource message is from the central unit to the first distributed unit.

15. A network node, configured to manage candidate cell configuration for a user equipment (UE) initially in communication with at least a first node, the network node operating as the first node and comprising:
a transceiver; and
processing hardware, configured to:
transmit, to a second node, a request for connectivity with the second node, the request including a procedure indicator and measurement results of one or more cells;
receive, from the second node, a response to the request, the response causing the first node to perform a secondary node procedure and the response including an information element conveying a list of two or more conditional configurations or a single conditional configuration according to the indication; and
transmit, to the UE, a radio resource message based at least on the list of two or more conditional configurations or the single conditional configuration.

16. The network node of claim 15, wherein the procedure indicator is an indicator for at least one of (i) a conditional handover (CHO) or (ii) an addition or change for a conditional primary secondary cell (C-PSCell).

17. The network node of claim 16, wherein the secondary node procedure is one of an immediate secondary node procedure or a conditional secondary node procedure.

18. The network node of claim 17, wherein the processing hardware is further configured to:
determine, when the secondary node procedure is the conditional secondary node procedure, that the information element includes the list of two or more conditional configurations;
retrieve, from the information element and in response to determining that the information element includes the list of two or more conditional configurations, one or more configurations in the list of two or more conditional configurations; and
generate, based on the one or more configurations, the radio resource message to be transmitted to the UE.

19. The network node of claim 17, wherein the processing hardware is further configured to:
determine, when the secondary node procedure is the immediate secondary node procedure, that the information element includes the single conditional configuration; and
generate, based on the single conditional configuration, the radio resource message to be transmitted to the UE.

20. The network node of claim 16, wherein the processing hardware is further configured to:
determine that the information element includes the list of two or more conditional configurations based on the request for connectivity including the indication of the addition or change for the C-PSCell; and
retrieve, from the information element and in response to determining that the information element includes the list of two or more conditional configurations, one or more configurations in the list of two or more conditional configurations; and
generate, from the one or more configurations, the radio resource message to be transmitted to the UE.
